(19) United States
(12) Patent Application Publication
(10) Pub. No.: US 2014/0247534 A1
(43) Pub. Date: Sep. 4, 2014

(54) ELECTROSTATIC CAPACITANCE ELEMENT AND RESONANCE CIRCUIT

(71) Applicant: Sonny Corporation, Tokyo (JP)

(72) Inventors: Noritaka Sato, Kanagawa (JP); Masayoshi Kanno, Kanagawa (JP)

(73) Assignee: SONY CORPORATION, Tokyo (JP)

(21) Appl. No.: 14/349,585

(22) PCT Filed: Oct. 2, 2012
(86) PCT No.: PCT/JP2012/075488

§ 371 Date: Apr. 3, 2014

(30) Foreign Application Priority Data
Oct. 24, 2011 (JP) 2011-232896

(51) Int. Cl. H01G 7/00

(52) U.S. Cl. CPC H01G 7/00
USPC 361/278

(57) ABSTRACT

There is provide an electrostatic capacitance element including a dielectric layer, a capacitance element body configured to include at least a pair of internal electrodes formed with the dielectric layer interposed therebetween, and an external terminal configured to be formed on a side surface of the capacitance element body and electrically connected to the internal electrode. Further, stress occurring due to a difference in a linear expansion coefficient between the dielectric layer and the internal electrode is concentrated on a center of a capacitor configured with the dielectric layer and the pair of internal electrodes between which the dielectric layer is interposed.

### TECHNICAL FIELD

The present invention relates to an electrostatic capacitance element and a resonance circuit including the electrostatic capacitance element.

### BACKGROUND ART

In recent years, as electronic devices have decreased in size and become more reliable, a demand for development of capacitance elements miniaturized as electronic parts used for electronic devices has arisen. Further, electrostatic capacitance elements in which a dielectric layer and an internal electrode are alternately stacked in order to reduce the size of the capacitance element and increase the capacitance of the capacitance element have been proposed.

Meanwhile, the inventor of the present application proposed a technique of improving electrical characteristics by residual stress occurring at the time of baking by forming an unrelated internal electrode in a capacitance element body forming electrostatic capacitance as a stress control unit in an capacitance element formed by stacking a plurality of internal electrodes (Patent Literature 1). In the technique disclosed in Patent Literature 1, as the stress control unit is formed by stacking the internal electrodes above and below the capacitance element body, it is possible to have internal stress caused by shrinkage of the dielectric layer when the capacitance element is baked to occur in the dielectric layer of the capacitance element body. As a result, it is possible to increase a relative dielectric constant of the dielectric layer of the capacitance element body.

### CITATION LIST

### Patent Literature

Patent Literature 1: WO2011/013658

### SUMMARY OF INVENTION

### Technical Problem

As described above, in the capacitance element formed by stacking the internal electrodes, it is possible to improve the dielectric constant and increase the electrostatic capacitance using the residual stress occurring at the time of baking. For this reason, the electrostatic capacitance element can be further miniaturized when it is possible to further increase the residual stress.

In light of the foregoing, it is an object of the present disclosure to improve electrical characteristics in an electrostatic capacitance element. It is another object to provide a resonance circuit having high reliability using the electrostatic capacitance element.

### Solution to Problem

An electrostatic capacitance element of the present disclosure includes a dielectric layer, a capacitance element body configured to include at least a pair of internal electrodes formed with the dielectric layer interposed therebetween, and an external terminal configured to be formed on a side surface of the capacitance element body and electrically connected to the internal electrode. Further, stress occurring due to a difference in a linear expansion coefficient between the dielectric layer and the internal electrode is concentrated on a center of a capacitor configured with the dielectric layer and the pair of internal electrodes between which the dielectric layer is interposed.

In the electrostatic capacitance element of the present disclosure, since stress (residual) occurs to be concentrated on a center of a capacitor, electrostatic capacitance per unit volume is increased.

A resonance circuit of the present disclosure includes a resonance capacitor configured to include the electrostatic capacitance element and a resonance coil connected to the resonance capacitor.

### Advantageous Effects of Invention

According to the present disclosure, residual stress in an electrostatic capacitance element increases, and thus electrical characteristics are improved.

### BRIEF DESCRIPTION OF DRAWINGS

FIG. 1A is a perspective view illustrating a variable capacitance element according to a first embodiment of the present disclosure, and FIG. 1B is a cross-sectional configuration view illustrating the variable capacitance element.

FIG. 2 is a plane configuration view illustrating an internal electrode configuring the variable capacitance element according to the first embodiment of the present disclosure.

FIG. 3 is a plane view illustrating two internal electrodes formed in the variable capacitance element according to the first embodiment of the present disclosure when the inside is viewed from above.

FIG. 4 is a plane configuration view illustrating an internal electrode of the variable capacitance element according to the first comparative example.

FIG. 5 is a plane configuration view illustrating an internal electrode of the variable capacitance element according to the second comparative example.

FIG. 6 is a plane configuration view illustrating an internal electrode configuring a variable capacitance element according to a modified example 1-1.

FIG. 7 is a plane configuration view illustrating an internal electrode configuring a variable capacitance element according to a modified example 1-2.

FIG. 8 is a plane configuration view illustrating an internal electrode configuring a variable capacitance element according to a modified example 1-3.

FIG. 9 is a plane configuration view illustrating an internal electrode configuring a variable capacitance element according to a modified example 1-4.

FIG. 10 is a plane configuration view illustrating an internal electrode configuring a variable capacitance element according to a second embodiment of the present disclosure.

FIG. 11 is a plane configuration view illustrating an internal electrode configuring a variable capacitance element according to a modified example 2-1.

FIG. 12 is a plane configuration view illustrating an internal electrode configuring a variable capacitance element according to a modified example 2-2.

FIG. 13 is a plane configuration view illustrating an internal electrode configuring a variable capacitance element according to a third embodiment of the present disclosure.

FIG. 14 is a plane configuration view illustrating an internal electrode configuring a variable capacitance element according to a modified example 3-1.

FIG. 15 is a plane configuration view illustrating an internal electrode configuring a variable capacitance element according to a modified example 3-2.

FIG. 16 is a plane configuration view illustrating an internal electrode configuring a variable capacitance element according to a modified example 3-3.

FIG. 17 is a perspective view of an external appearance of a variable capacitance element according to a fourth embodiment of the present disclosure.

FIG. 18 is a perspective view of an external appearance of a variable capacitance element according to a modified example 4-1.

FIG. 19 is a plane configuration view illustrating a dielectric layer and an internal electrode configuring a variable capacitance element according to a modified example 4-2.

FIG. 20 is a plane configuration view illustrating a dielectric layer and an internal electrode configuring a variable capacitance element according to a modified example 4-3.

FIG. 21 is a plane configuration view illustrating a dielectric layer and an internal electrode configuring a variable capacitance element according to a modified example 4-4.

FIG. 22 is a plane configuration view illustrating a dielectric layer and an internal electrode configuring a variable capacitance element according to a modified example 4-5.

FIG. 23 is a plane configuration view illustrating a dielectric layer and an internal electrode configuring a variable capacitance element according to a modified example 4-6.

FIG. 24 is a plane configuration view illustrating a dielectric layer and an internal electrode configuring a variable capacitance element according to a modified example 4-7.

FIG. 25 is a plane configuration view illustrating a dielectric layer and an internal electrode configuring a variable capacitance element according to a modified example 4-8.

FIG. 26 is a plane configuration view illustrating a dielectric layer and an internal electrode configuring a variable capacitance element according to a fifth embodiment of the present disclosure.

FIG. 27 is a plane configuration view illustrating a dielectric layer and an internal electrode configuring a variable capacitance element according to a modified example 5-1.

FIG. 28 is a plane view illustrating two internal electrodes of a variable capacitance element according to a modified example 5-1 when the inside is viewed from above.

FIG. 29 is a plane configuration view illustrating a dielectric layer and an internal electrode configuring a variable capacitance element according to a modified example 5-2.

FIG. 30 is a plane configuration view illustrating a dielectric layer and an internal electrode configuring a variable capacitance element according to a modified example 5-3.

FIG. 31 is a perspective view of an external appearance of a variable capacitance element according to a sixth embodiment of the present disclosure.

FIG. 32 is a plane configuration view illustrating an internal electrode configuring a variable capacitance element according to the second embodiment of the present disclosure.

FIG. 33 is a diagram illustrating a variable capacitance element body according to a sixth embodiment of the present disclosure when the inside is viewed from above.

FIG. 34 is a plane configuration view illustrating a dielectric layer and an internal electrode configuring a variable capacitance element according to a modified example 6-1.

FIG. 35 is a plane configuration view illustrating a dielectric layer and an internal electrode configuring a variable capacitance element according to a modified example 6-2.

FIG. 36A is a schematic perspective view illustrating a variable capacitance element according to a seventh embodiment of the present disclosure, and FIG. 36B is a cross-sectional configuration view illustrating the variable capacitance element.

FIG. 37 is an exploded view illustrating a variable capacitance element body according to the seventh embodiment when viewed from one side in a long-side direction.

FIG. 38A is a plane configuration view illustrating a first internal electrode 88 when viewed from above, and FIG. 38B is a configuration view illustrating the first internal electrode 88 when viewed from one side.

FIG. 39A is a plane configuration view illustrating a second internal electrode 89 when viewed from above, and FIG. 39B is a configuration view illustrating the second internal electrode 89 when viewed from one side.

FIG. 40A is a plane configuration view illustrating a fourth internal electrode 91 when viewed from above, and FIG. 40B is a configuration view illustrating the fourth internal electrode 91 when viewed from one side.

FIG. 41 is a circuit configuration view illustrating a voltage control circuit in which the variable capacitance element according to the seventh embodiment is integrated.

FIG. 42 is an exploded view illustrating a variable capacitance element body of a variable capacitance element according to a modified example 7-1 when viewed from one side in a long-side direction.

FIG. 43 is an exploded view illustrating a variable capacitance element body of a variable capacitance element according to a modified example 7-2 when viewed from one side in a long-side direction.

FIG. 44A is a schematic perspective view illustrating a variable capacitance element according to an eighth embodiment of the present disclosure, and FIG. 44B is a cross-sectional configuration view of the variable capacitance element.

FIG. 45 is an exploded view illustrating a variable capacitance element body according to the eighth embodiment of the present disclosure when viewed from one side in a long-side direction.

FIG. 46A is a plane configuration view illustrating a first internal electrode 123 when viewed from above, and FIG. 46B is a configuration view illustrating the first internal electrode 123 when viewed from one side.

FIG. 47A is a plane configuration view illustrating a second internal electrode 124 when viewed from above, and FIG. 47B is a configuration view illustrating the second internal electrode 124 when viewed from one side.

FIG. 48A is a plane configuration view illustrating a fourth internal electrode 126 when viewed from above, and FIG. 48B is a configuration view illustrating the fourth internal electrode 126 when viewed from one side.

FIG. 49 is a configuration view illustrating a first internal electrode to a sixth internal electrode of the variable capacitance element according to an eighth embodiment of the present disclosure when the inside is viewed from above.

FIG. 50 is a circuit configuration view illustrating a voltage control circuit in which the variable capacitance element according to the eighth embodiment is integrated.

FIG. 51 is an exploded view illustrating a variable capacitance element body of a variable capacitance element according to a modified example 8-1 when viewed from one side in a long-side direction.

FIG. 52A is a schematic perspective view illustrating a variable capacitance element according to a ninth embodiment of the present disclosure, and FIG. 52B is a cross-sectional configuration view of the variable capacitance element.

FIG. 53 is an exploded view illustrating a variable capacitance element body according to the ninth embodiment of the present disclosure when viewed from one side in a long-side direction.

FIG. 54A is a plane configuration view illustrating a first internal electrode 144 when viewed from the top, and FIG. 54B is a configuration view illustrating the first internal electrode 144 when viewed from one side.

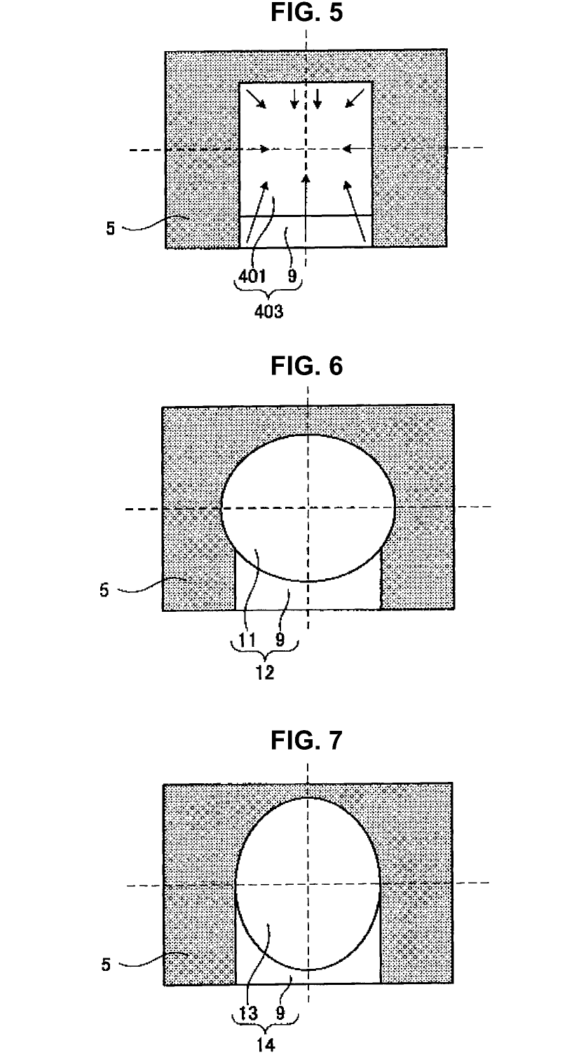

FIG. 5 is a configuration view illustrating a first internal electrode to a sixth internal electrode of the variable capacitance element according to the ninth embodiment of the present disclosure when the inside is viewed from above.

FIG. 56 is a circuit configuration view illustrating a voltage control circuit in which the variable capacitance element according to the ninth embodiment is integrated.

FIG. 57 is an exploded view illustrating a variable capacitance element body of a variable capacitance element according to a modified example 9-1 when viewed from one side in a long-side direction.

FIG. 58 is a block configuration view illustrating a receiving system circuit unit of a non-contact IC card using a resonance circuit according to a tenth embodiment of the present disclosure.

### DESCRIPTION OF EMBODIMENTS

Hereinafter, exemplary electrostatic capacitance elements and exemplary resonance circuits having the same according to embodiments of the present disclosure will be described with reference to the appended drawings. The embodiments of the present disclosure will be described in the following order. Further, the following embodiments will be described in connection with an example of a variable capacitance element in which a capacitance value varies according to an applied voltage. Further, the present disclosure is not limited to the following embodiments.

1. First embodiment: variable capacitance element in which symmetry of electrode body configuring capacitance is increased

2. Second embodiment: variable capacitance element in which symmetry of internal electrode is increased in pseudo manner

3. Third embodiment: variable capacitance element in which symmetry is increased by forming floating electrode

4. Fourth embodiment: variable capacitance element in which symmetry of shape of variable capacitance element body is increased.

5. Fifth embodiment: variable capacitance element in which shape of variable capacitance element body is same as shape of electrode body configuring capacitance

6. Sixth embodiment: variable capacitance element in which plurality of connection electrodes are formed in one internal electrode

7. Seventh embodiment: variable capacitance element (1 thereof) in which plurality of capacitors that are connected in series in stacked direction of internal electrodes are configured

8. Eighth embodiment: variable capacitance element (2 thereof) in which plurality of capacitors that are connected in series in stacked direction of internal electrodes are configured

9. Ninth embodiment: variable capacitance element (3 thereof) in which plurality of capacitors that are connected in series in stacked direction of internal electrodes are configured

10. Tenth embodiment: resonance circuit in which variable capacitance element is integrated

### 1. First Embodiment

### Configuration of Variable Capacitance Element

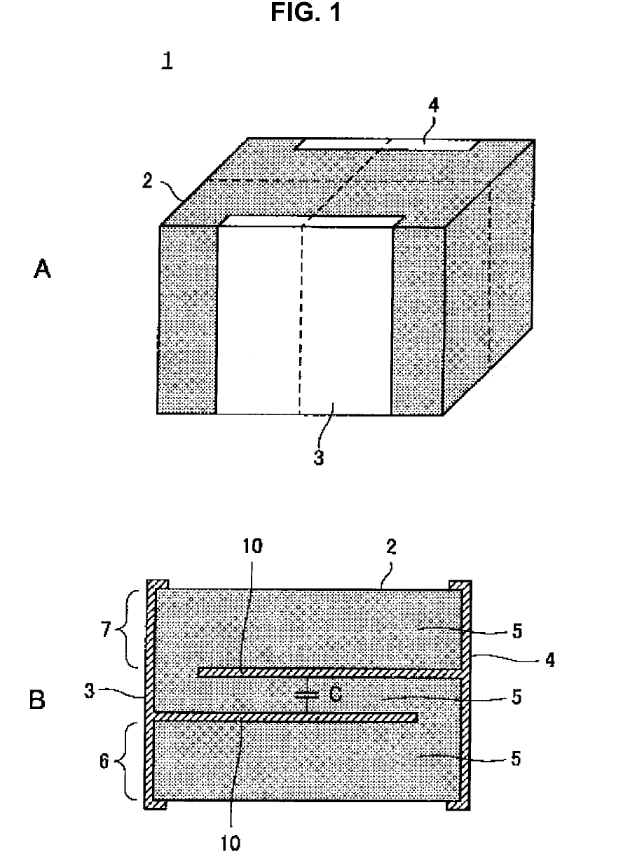

First, a variable capacitance element according to the first embodiment of the present disclosure will be described. FIG. 1A is a perspective view illustrating the variable capacitance element according to the present embodiment, and FIG. 1B is a cross-sectional configuration view illustrating the variable capacitance element according to the present embodiment. FIG. 2 is a plane configuration view illustrating an internal electrode configuring the variable capacitance element according to the present embodiment. In FIGS. 1A and 2, lines passing through the center of gravity of an internal electrode and a dielectric layer are indicated by dotted lines. The same applies in subsequent drawings.

As illustrated in FIG. 1A, the variable capacitance element 1 according to the present embodiment includes a variable capacitance element body 2 configured with a rectangular parallelepiped member and two external terminals 3 and 4.

As illustrated in FIG. 1B, the variable capacitance element body 2 includes two internal electrodes 10 stacked with a dielectric layer 5 interposed therebetween, a lower dielectric layer 6 stacked below the two internal electrodes 10, and an upper dielectric layer 7 stacked above the two internal electrodes 10. In other words, in the present embodiment, the surfaces of the internal electrodes 10 are exposed through the lower dielectric layer 6 and the upper dielectric layer 7. The variable capacitance element body 2 has the structure in which the dielectric layers 5 of a sheet shape in which conductive layers configuring the internal electrodes 10 are formed are stacked, and each of the dielectric layers 5 formed in the sheet shape has a rectangular-shaped plane as a plane on which the internal electrodes 10 are formed.

In the present embodiment, since the variable capacitance element 1 is configured to have capacitance varying according to an applied voltage, the dielectric layer 5 is made of a ferroelectric material. Specifically, a dielectric material causing ionic polarization may be used as such a ferroelectric material. The ferroelectric material causing the ionic polarization is a ferroelectric material that is made of an ionic crystal material and electrically polarizes as atoms of positive ions and negative ions are displaced. Generally, the ferroelectric material causing the ionic polarization is expressed by a chemical formula ABO₃ (O is the element oxygen) when two certain elements are A and B and has a perovskite structure. Examples of the ferroelectric material include barium titanate (BaTiO₃), potassium niobate (KNbO₃), and lead titanate (PbTiO₃). Further, as a material used to form the dielectric layer 5, PZT (lead zirconium titanate) in which lead zirconate (PbZrO₃) is mixed with lead titanate (PbTiO₃) may be used.

Further, a ferroelectric material causing electronic polarization may be used as the ferroelectric material. In the ferroelectric material, separation into a portion biased to positive charges and a portion biased to negative charges is performed, and an electric dipole moment occurs, leading to polarization. As such a material, a rare earth iron oxide that forms polarization as a charge plane of Fe²⁺ and a charge plane of Fe³⁺ are formed and shows ferroelectric characteristics was reported in the past. In this system, when a rare-earth element is represented as RE and an iron group element is represented as TM, a material expressed by a molecular formula (RE)-(TM)₂-O₄ (O: the element oxygen) is reported to have a high-dielectric constant. Examples of the rare-earth element include Y, Er, Yb, and Lu (particularly, Y and a heavy rare-earth element), and examples of the iron group element include Fe, Co, and Ni (particularly, Fe). Further, examples of (RE)-(TM)₂-O₄ include ErFe₂O₄, LuFe₂O₄, and YFe₂O₄.

As illustrated in FIG. 2, the internal electrode 10 includes an electrode body 8 having a circular shape and a connection electrode 9 that is connected to the electrode body 8 and formed such that an end portion is exposed in the side surface of the variable capacitance element body 2. Further, the center of gravity of the electrode body 8 of the internal electrode 10 is aligned with the center of the dielectric layer 5 formed in the sheet shape. The internal electrode 10 may be formed using a conductive paste including, for example, a fine metallic powder (Pd, Pd/Ag, Ni, or the like). Further, in the present embodiment, the two internal electrodes 10 are formed of the same material. However, the present disclosure is not limited to this example, and for example, the internal electrodes 10 formed of a material that differs according to a purpose or the like may be stacked.

The two internal electrodes 10 are stacked with the dielectric layer 5 interposed therebetween such that sides of the electrode body 8 overlap the center of gravity in the stacked direction. Further, the respective connection electrodes 9 configuring the respective internal electrodes 10 are arranged to be positioned to face each other. In other words, one internal electrode 10 has a configuration obtained by rotating the other internal electrode 10 180 degrees on an axis perpendicular to an electrode plane, and in the variable capacitance element body 2, the connection electrode 9 is exposed at the opposite side.

The external terminals 3 and 4 are formed on the sides of the variable capacitance element body 2, and electrically connected to the exposed connection electrode 9. In other words, in the present embodiment, the two external terminals 3 and 4 are formed on the two sides of the variable capacitance element body 2 that are opposite to each other. Further, the two external terminals 3 and 4 are formed to cover the sides of the variable capacitance element body 2 in the stacked direction of the internal electrode 10 and extend beyond the upper surface and the lower surface of the variable capacitance element body 2.

Through this configuration, in the present embodiment, a capacitor C is formed between the two opposite electrode bodies 8. Further, when a desired voltage is applied between the two external terminals 3 and 4, the relative dielectric constant of the dielectric layer 5 between the electrode bodies 8 varies.

[Manufacturing Method]

An exemplary method of manufacturing the variable capacitance element 1 having the above configuration will be described. First, a dielectric sheet made of a desired dielectric material is prepared. The dielectric sheet configures each dielectric layer 5 in the variable capacitance element body 2, and has a thickness of, for example, about 2.5 μm. The dielectric sheet may be formed by applying a paste-like dielectric material on a PET (polyethylene terephthalate) film at a desired thickness. Further, a mask in which a region corresponding to a forming region of the internal electrode 10 illustrated in FIG. 2 is opened is prepared.

Then, for example, a conductive paste made from a fine metallic powder of Pt, Pd, Pd/Ag, Ni, a Ni alloy, or the like is adjusted. Then, the conductive paste is applied (silk-printed) on one surface of the dielectric sheet using each mask prepared in a previous step. As a result, a dielectric sheet in which the internal electrode 10 is formed on one surface is formed. At this time, the dielectric sheet is formed such that the center thereof matches the center (the center of gravity) of the electrode body 8 of each electrode.

Then, the dielectric sheets on which the internal electrode 10 is formed are stacked in a desired order after aligning a direction of the surface on which each electrode is printed. At this time, stacking is performed such that the sides of the electrode bodies of the two internal electrodes 10 overlap the center thereof in the stacked direction. Further, dielectric sheets on which no electrode is printed are stacked above and below the stacked body and crimped.

Then, the crimped member is subjected to high-temperature backing under a reductive atmosphere, and the dielectric sheet is integrated into each electrode formed of the conductive paste. As a result, the variable capacitance element body 2 is manufactured. Thereafter, the two external terminals 3 and 4 are attached to a certain position of the sides of the variable capacitance element body 2. In the present embodiment, the variable capacitance element 1 is manufactured through the above-described method.

Meanwhile, in the variable capacitance element 1 according to the present embodiment, residual stress (compression stress) occurs due to a difference of a shrinkage rate at the time of sintering of the dielectric material and the electrode material. The residual stress occurs in a direction in which the electrode material and the dielectric material are shrunk in each layer. Meanwhile, in the variable capacitance element 1 according to the present embodiment, the two electrode bodies 8 configuring the capacitor C have the same shape and are stacked such that the sides overlap the center in the stacked direction of the internal electrode 10. Further, the electrode body 8 is formed such that the center is aligned with the center of the dielectric layer 5. For this reason, in the variable capacitance element 1 according to the present embodiment, the internal electrodes 10 and the dielectric layers 5 are shrunk toward the centers thereof. Thus, it is possible to cause the residual stress occurring at the time of sintering be concentrated at the center of the capacitor C formed by the two internal electrodes 10.

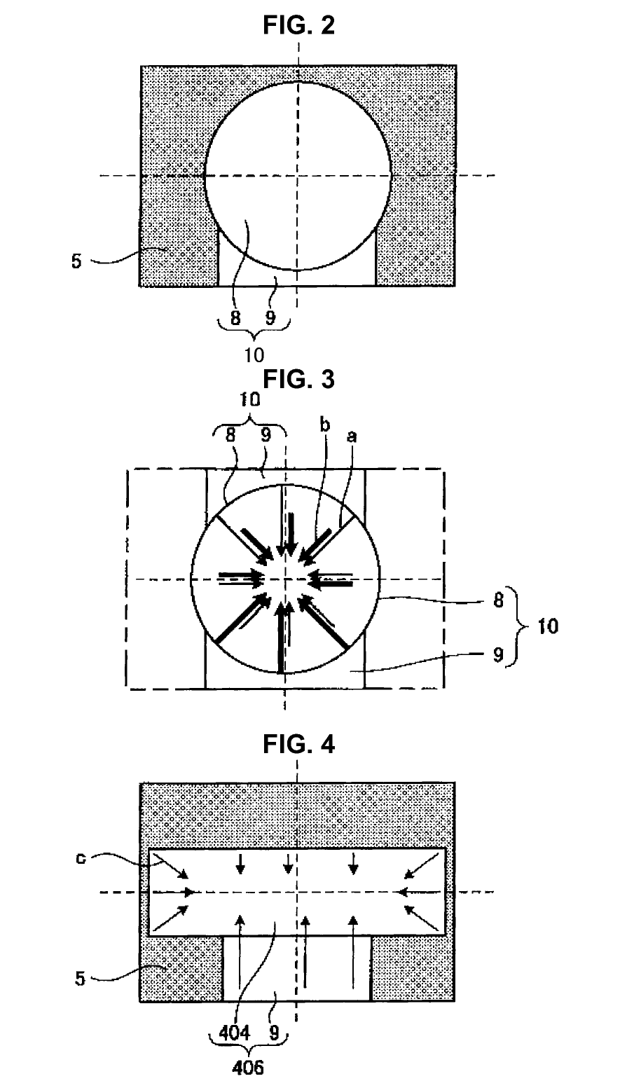

Further, in the variable capacitance element 1 according to the present embodiment, the electrode body 8 forming the capacitor C is formed in a circular shape. Thus, it is possible to cause the residual stress occurring at the time of baking to be concentrated toward the center. FIG. 3 is a plane view illustrating the two internal electrodes 10 formed in the variable capacitance element 1 according to the present embodiment when the inside is viewed from above. In FIG. 3, a direction and size of the residual stress occurring in the internal electrode 10 of the lower layer are indicated by an arrow a, and a direction and size of the residual stress occurring in the internal electrode 10 of the upper layer are indicated by an arrow b.

FIG. 4 illustrates a plane configuration of an internal electrode 406 of a variable capacitance element according to a first comparative example, and FIG. 5 illustrates a plane configuration of an internal electrode 403 of a variable capacitance element according to a second comparative example. The variable capacitance elements of the first comparative example and the second comparative example are different from the variable capacitance element 1 according to the present embodiment in the shape of the electrode body forming the capacitor. In the first comparative example, an electrode body 404 has a rectangular shape as illustrated in FIG. 4, and in the second comparative example, an electrode body 401 has a square shape as illustrated in FIG. 5. In FIG. 4, an occurrence direction and size of the residual stress occurring at the time of baking are indicated by an arrow a, and in FIG. 5, an occurrence direction and a size of the residual stress occurring at the time of baking are indicated by an arrow d.

In the first comparative example, as illustrated in FIG. 4, the electrode body 404 of the internal electrode 406 has a rectangular shape. For this reason, the residual stress occurring at the time of baking differs in size from residual stress occurring in a long-side direction of the electrode body 404 and residual stress occurring in a short-side direction as indicated by an arrow c. Further, since the electrode body 404 has a shape in which symmetry in an electrode plane is low, components of the residual stress that are directed toward the center of gravity are small. In addition, when the size of the residual stress occurring at the side at which the connection electrode 9 is formed is added, the size or the occurrence direction of the residual stress occurring in the internal electrode 406 is dispersed.

Further, in the second comparative example, as illustrated in FIG. 5, the electrode body 401 of the internal electrode 403 has a square shape. For this reason, the residual stress occurring at the time of baking is affected by the residual stress occurring at the side at which the connection electrode 9 is formed as indicated by the arrow d, and the residual stress occurring in the internal electrode 403 is unbalanced within a plane and large at the connection electrode 9 side. Further, since the electrode body 404 has a shape in which symmetry in an electrode plane is low, components of the residual stress that are directed toward the center of gravity are small.

Meanwhile, in the present embodiment, the electrode body 8 of the internal electrode 10 has the circular shape. For this reason, the shape is high in planar symmetry, and the residual stress (compression stress) occurring at the time of baking occurs at the side of the electrode body 8 toward the center of gravity. Further, when the size of the residual stress occurring at the side at which the connection electrode 9 is formed is added, the residual stress occurring from the side at which the connection electrode 9 is formed toward the center increases. However, since the electrode body 8 has the circular shape, a change in the residual stress is slow in the internal electrode 10, and the residual stress occurring at the side at which the connection electrode 9 is formed occurs toward the center of gravity of the electrode body 8 as well.

As a result, the residual stress is concentrated toward the center of the electrode body 8 forming the capacitance of the internal electrode 10, and thus it is possible to further increase tensile stress in the stacked direction (the electric field direction) of the internal electrode 10. Thus, it is possible to improve electrical characteristics, for example, it is possible to increase electrostatic capacitance per unit volume in a capacitor or increase a variable rate.

In the present embodiment, the electrode body 8 of the internal electrode 10 has the circular shape, but the same effects can be obtained as long as the electrode body 8 has a shape in which symmetry with respect to an axis that passes through the center of gravity of the electrode body 8 and is horizontal to an electrode plane is high. Although there are a number of axes that pass through the center of gravity of the electrode body 8 and are horizontal to an electrode plane, “symmetry is high” herein means that an electrode shape is a shape that can overlap (or almost overlap) an original electrode shape at a small rotary angle. In the present embodiment, as the shape of the electrode body 8 having high symmetry, a regular pentagon overlaps an original electrode shape by rotation of 72 or less degrees and is high in rotational symmetry. Thus, it is preferable that an arbitrary shape become an original shape by rotation of 72 degrees or less. A shape that is high in one of linear symmetry and rotational symmetry is desirable, but a shape that is high in both of linear symmetry and rotational symmetry is more desirable.

Next, modified examples of the variable capacitance element according to the present embodiment will be described.

### Modified Example 1-1

FIG. 6 illustrates a plane configuration of an internal electrode configuring a variable capacitance element according to a modified example 1-1. In FIG. 6, parts corresponding to those of FIG. 2 are denoted by the same reference numerals, and repeated explanation is omitted.

In the variable capacitance element according to the modified example 1-1, an electrode body 11 of an internal electrode 12 has an elliptical shape. In the modified example 1-1, the long diameter direction of the elliptical shape serves as the long axis direction of the dielectric layer 5, and the short diameter direction serves as the short axis direction of the dielectric layer 5.

In the modified example 1-1, although not shown, a variable capacitance element body is configured by stacking the internal electrodes 12 illustrated in FIG. 6 as two layers such that the side and the center of the electrode body 11 overlap in the stacked direction, and the connection electrodes 9 are exposed at the opposite sides. Further, external terminals that are electrically connected to the respective connection electrodes 9 exposed at almost the center of the variable capacitance element body in the long axis direction are formed, and the variable capacitance element of the modified example 1-3 is formed. In the modified example 1-1, a capacitor is configured of a pair of electrode bodies 11 that are stacked.

In the modified example 1-1, the electrode body 11 configuring the capacitor has an elliptical shape that is high in symmetry with respect to an axis that passes through the center of gravity of the electrode body 11 and is horizontal to an electrode plane. Thus, it is possible to cause the residual stress occurring in the plane of the internal electrode 12 to be concentrated at the center of gravity, and the same effects as in the present embodiment can be obtained.

### Modified Example 1-2

FIG. 7 illustrates a plane configuration of an internal electrode configuring a variable capacitance element according to a modified example 1-2. In FIG. 7, parts corresponding to those of FIG. 2 are denoted by the same reference numerals, and repeated explanation is omitted.

In the variable capacitance element according to the modified example 1-2, an electrode body 13 of an internal electrode 14 has an elliptical shape. In the modified example 2, the long diameter direction of the elliptical shape serves as the short axis direction of the dielectric layer 5, and the short diameter direction serves as the long axis direction of the dielectric layer 5.

In the modified example 1-2, although not shown, a variable capacitance element body is configured by stacking the internal electrodes 14 illustrated in FIG. 7 as two layers such that the side and the center of the electrode body 13 overlap in the stacked direction, and the connection electrodes 9 are exposed at the opposite sides. Further, external terminals that are electrically connected to the respective connection electrodes 9 exposed at almost the center of the variable capacitance element body in the long axis direction are formed, and the variable capacitance element of the modified example 1-2 is formed. In the modified example 1-2, a capacitor is configured of a pair of electrode bodies 13 that are stacked.

In the modified example 1-2, the electrode body 13 configuring the capacitor has an elliptical shape that is high in symmetry with respect to an axis that passes through the center of gravity of the electrode body 13 and is horizontal to an electrode plane. Thus, it is possible to cause the residual stress occurring in the plane of the internal electrode 14 to be concentrated at the center of gravity, and the same effects as in the present embodiment can be obtained.

### Modified Example 1-3

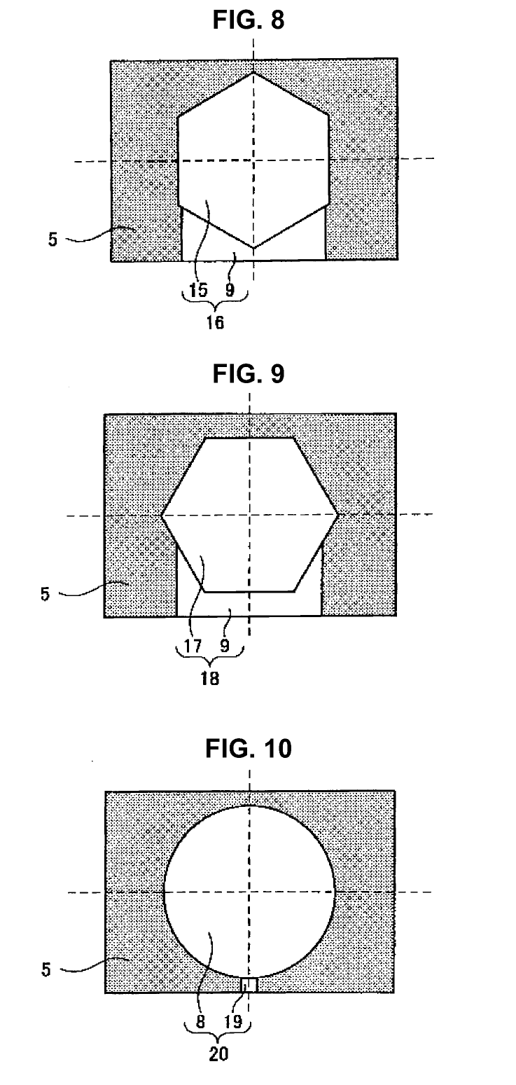

FIG. 8 illustrates a plane configuration of an internal electrode configuring a variable capacitance element according to a modified example 1-3. In FIG. 8, parts corresponding to those of FIG. 2 are denoted by the same reference numerals, and repeated explanation is omitted.

In the variable capacitance element according to the modified example 1-3, an electrode body 15 of an internal electrode 16 has a regular hexagonal shape, and is configured such that two vertexes of a regular hexagon overlap on a straight line passing through the center of the dielectric layer 5 in the short axis direction.

In the modified example 1-3, although not shown, a variable capacitance element body is configured by stacking the internal electrodes 16 illustrated in FIG. 8 as two layers such that the side and the center of gravity of the electrode body 15 overlap in the stacked direction, and the connection electrodes 9 are exposed at the opposite sides. Further, external terminals that are electrically connected to the respective connection electrodes 9 exposed at almost the center of the variable capacitance element body in the long axis direction are formed, and the variable capacitance element of the modified example 1-3 is formed. In the modified example 1-3, a capacitor is configured of a pair of electrode bodies 15 that are stacked.

In the modified example 1-3, the electrode body 15 configuring the capacitor has a regular hexagonal shape that is high in symmetry with respect to an axis that passes through the center of gravity of the electrode body 15 and is horizontal to an electrode plane. Thus, it is possible to cause the residual stress occurring in the plane of the internal electrode 16 to be concentrated at the center of gravity, and the same effects as in the present embodiment can be obtained.

### Modified Example 1-4

FIG. 9 illustrates a plane configuration of an internal electrode configuring a variable capacitance element according to a modified example 1-4. In FIG. 9, parts corresponding to those of FIG. 2 are denoted by the same reference numerals, and repeated explanation is omitted.

In the variable capacitance element according to the modified example 1-4, an electrode body 17 of an internal electrode 18 has a regular hexagonal shape, and is configured such that two vertexes of a regular hexagon overlap on a straight line passing through the center of the dielectric layer 5 in the long axis direction.

In the modified example 1-4, although not shown, a variable capacitance element body is configured by stacking the internal electrodes 18 illustrated in FIG. 9 as two layers such that the side and the center of gravity of the electrode body 17 overlap in the stacked direction, and the connection electrodes 9 are exposed at the opposite sides. Further, external terminals that are electrically connected to the respective connection electrodes 9 exposed at almost the center of the variable capacitance element body in the long axis direction are formed, and the variable capacitance element of the modified example 1-4 is formed. In the modified example 1-4, a capacitor is configured of a pair of electrode bodies 17 that are stacked.

In the modified example 1-4, the electrode body 17 configuring the capacitor has a regular hexagonal shape that is high in symmetry with respect to an axis that passes through the center of gravity of the electrode body 17 and is horizontal to an electrode plane. Thus, it is possible to cause the residual stress occurring in the plane of the internal electrode 18 to be concentrated at the center of gravity, and the same effects as in the present embodiment can be obtained.

Meanwhile, in the modified examples 1-3 and 1-4, although the electrode body has the regular hexagonal shape, the same effects as in the present embodiment can be obtained as long as the electrode body has a regular pentagonal or higher-order polygonal shape, and higher effects are obtained when the electrode body has a shape closer to a circular shape. As described above, when the electrode body configuring the capacitor has a regular pentagonal or higher-order polygonal shape, a circular shape, or an elliptical shape, it is possible to cause occurring residual stress to be further concentrated at the center of gravity of the electrode body compared to when the electrode body has the square shape.

### 2. Second Embodiment

Next, a variable capacitance element according to a second embodiment of the present disclosure will be described. The present embodiment differs from the first embodiment in a connection electrode configuring an internal electrode, but has the same shape and cross-sectional configuration as the variable capacitance element of the first embodiment illustrated in FIGS. 1A and 1B, and thus illustration thereof is omitted.

FIG. 10 is a plane configuration view illustrating an internal electrode configuring a variable capacitance element according to the present embodiment. In FIG. 10, parts corresponding to those of FIG. 2 are denoted by the same reference numerals, and repeated explanation is omitted.

As illustrated in FIG. 10, in the variable capacitance element according to the present embodiment, an internal electrode 20 includes an electrode body 8 having a circular shape and a connection electrode 19 that is exposed at the side of the variable capacitance element body and connected to an external terminal. Further, the connection electrode 19 is formed with the size in which residual stress occurring around the connection electrode 19 does not influence residual stress occurring in the electrode body 8 at the time of sintering of the variable capacitance element body. Thus, the connection electrode 19 is formed with the area size sufficiently smaller than the area size of the electrode body 8, and in the present embodiment, the connection electrode 19 is formed such that an end portion of the connection electrode 19 connected to the external terminal has a width sufficiently smaller than the diameter of the electrode body 8.

Here, in order to prevent the residual stress occurring around the connection electrode 19 from influencing the residual stress occurring in the electrode body 8, it is preferable that the width of the end portion of the connection electrode 19 connected to the external terminal be set to, for example, a quarter (¼) or less of the diameter of the electrode body 8

In the present embodiment, although not shown, a variable capacitance element body is configured such that the internal electrodes 20 illustrated in FIG. 10 are stacked such that the side and the center of gravity of the electrode body 8 overlap in the stacked direction, and the connection electrodes 19 respectively configuring the stacked internal electrodes 20 are exposed at the opposite sides. Further, external terminals that are electrically connected to the respective connection electrodes 19 exposed at almost the center of the variable capacitance element body in the long axis direction are formed, and the variable capacitance element according to the present embodiment is formed. In the present embodiment, a capacitor is configured of a pair of electrode bodies 8 that are stacked.

In the present embodiment, as the width (the area size) of the connection electrode 19 is set to be small, it is possible to increase symmetry of the shape of the internal electrode 20 including the connection electrode 19 in a pseudo manner. Here, “symmetry” means symmetry with respect to an axis that passes through the center of gravity of the electrode body 8 and is horizontal to an electrode plane, similarly to the first embodiment.

### Modified Example 2-1

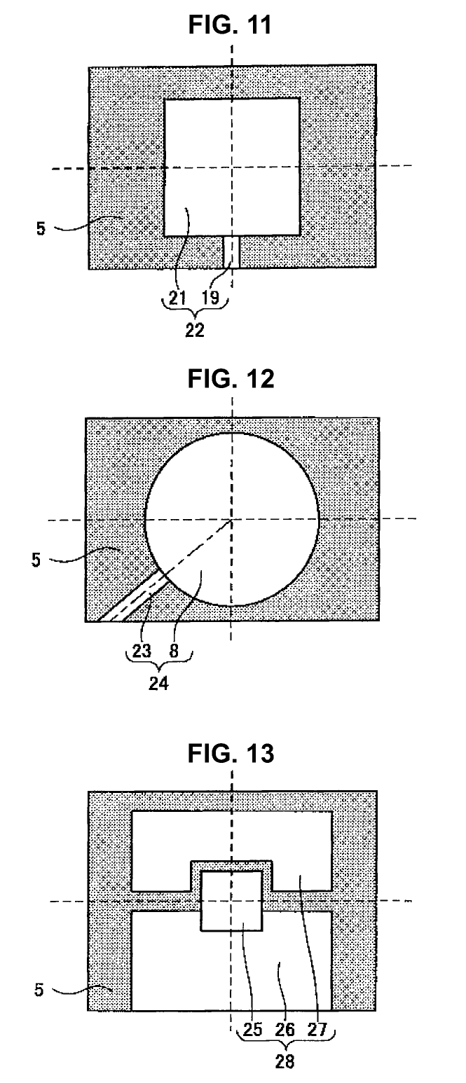

FIG. 11 illustrates a plane configuration of an internal electrode configuring a variable capacitance element according to a modified example 2-1. In FIG. 11, parts corresponding to those of FIG. 10 are denoted by the same reference numerals, and repeated explanation is omitted.

In the variable capacitance element according to the modified example 2-1, an electrode body 21 of an internal electrode 22 has a square shape. In the modified example 2-1, the connection electrode 19 is formed with an area size sufficiently smaller than the area size of the electrode body 21, and the connection electrode 19 is formed with a width sufficiently smaller than the width of the square shape. In the modified example 2-1, in order to prevent the residual stress occurring around the connection electrode 19 from influencing the residual stress occurring in the electrode body 21, it is preferable that the width of the end portion of the connection electrode 19 connected to the external terminal be set to, for example, one n-th (1/n) or less of the maximum width of the electrode body 21.

In the modified example 2-1, although not shown, a variable capacitance element body is configured by stacking the internal electrodes 21 illustrated in FIG. 11 such that the side and the center of gravity of the electrode body 21 overlap in the stacked direction, and the connection electrodes 19 are exposed at the opposite sides. Further, external terminals that are electrically connected to the respective connection electrodes 19 exposed at almost the center of the variable capacitance element body in the long axis direction are formed, and the variable capacitance element according to the present embodiment is formed. In the present embodiment, a capacitor is configured of a pair of electrode bodies 21 that are stacked.

In the modified example 2-1, as the area size of the connection electrode 19 is set to be small, it is possible to increase symmetry of the internal electrode 22 in a pseudo manner. In other words, the symmetry of the internal electrode 22 is higher than in the second comparative example in which the width of the connection electrode is almost the same as the width of the electrode body. Thus, it is possible to cause the residual stress occurring in a plane of the internal electrode 22 to be concentrated from the respective vertexes of the internal electrode 22 to the center, and the same effects can be obtained.

Meanwhile, in the second embodiment and the modified example 2-1, although the electrode body has the circular shape and the square shape, the same effects as in the present embodiment can be obtained when the electrode body has a regular pentagonal or higher-order polygonal shape or an elliptical shape. In this case, the same effects can be obtained as long as the connection electrode is formed with the width sufficiently smaller than the width of the electrode body, and the electrode body has a shape that is high in symmetry with respect to an axis that passes through the center of gravity of the electrode body and is horizontal to the electrode plane.

### Modified Example 2-2

FIG. 12 illustrates a plane configuration of an internal electrode configuring a variable capacitance element according to a modified example 2-2. In FIG. 12, parts corresponding to those of FIG. 10 are denoted by the same reference numerals, and repeated explanation is omitted.

The internal electrode 20 of the variable capacitance element illustrated in FIG. 10 is formed such that the connection electrode 19 is exposed at almost the center of the side of the variable capacitance element body in the long axis direction. On the other hand, in the modified example 2-2, a connection electrode 23 configuring an internal electrode 24 is formed to be exposed at the position deviated from the center of the side of the variable capacitance element body in the long axis direction.

Further, in the modified example 2-2, as illustrated in FIG. 12, the connection electrode 23 configuring the internal electrode 24 is arranged on an axis passing through the center of gravity of the electrode body 8.

As the connection electrode 23 is arranged on the axis passing through the center of gravity of the electrode body 8 configuring the capacitor as in the modified example 2-2, it is possible to increase a degree of freedom in a design of an external terminal without much damage to the symmetry of the residual stress.

In addition, the same effects as in the first embodiment and the second embodiment can be obtained.

### 3. Third Embodiment

Next, a variable capacitance element according to a third embodiment of the present disclosure will be described. The present embodiment differs from the first embodiment in a configuration of an internal electrode, but has the same shape and cross-sectional configuration as the variable capacitance element of the first embodiment illustrated in FIGS. 1A and 1B, and thus illustration thereof is omitted.

FIG. 13 is a plane configuration view illustrating an internal electrode 28 configuring a variable capacitance element according to the present embodiment. In FIG. 13, parts corresponding to those of FIG. 2 are denoted by the same reference numerals, and repeated explanation is omitted.

As illustrated in FIG. 13, in the variable capacitance element according to the present embodiment, the internal electrode 28 includes an electrode body 25 of a square shape, a connection electrode 26 that is connected to the side of the electrode body 25, exposed at the side of the variable capacitance element body, and connected to an external terminal, and a floating electrode 27.

The electrode body 25 is formed at almost the center of the dielectric layer 5 such that the center of the square shape is aligned with the center of the dielectric layer 5.

The connection electrode 26 is connected to one side of the electrode body 25, and formed to have an end portion that is exposed at the side of the capacitance element body.

The floating electrode 27 is formed in a region at the side opposite to the connection electrode 26 with the electrode body 25 interposed therebetween. Further, the floating electrode 27 has almost the same shape as the connection electrode 26, and is formed to be nearly symmetrical to the connection electrode 26 with respect to an axis passing through the center of gravity of the electrode body 25. Here, the floating electrode 27 is not connected to the electrode body 25, and is formed not to be exposed at the side of the variable capacitance element body. Thus, when the variable capacitance element is driven, external electric potential is not supplied to the floating electrode 27.

In the present embodiment, although not shown, a variable capacitance element body is configured by stacking the internal electrodes 28 illustrated in FIG. 13 as two layers such that the side and the center of the electrode body 25 overlap in the stacked direction, and the connection electrodes 26 are exposed at the opposite sides. Further, external terminals that are electrically connected to the respective connection electrodes 26 exposed at almost the center of the variable capacitance element body in the long axis direction are formed, and the variable capacitance element according to the present embodiment is formed. In the present embodiment, a capacitor is configured of a pair of electrode bodies 25 that are stacked.

In the present embodiment, as the floating electrode 27 is formed to be symmetric to the connection electrode 26 with the electrode body 25 interposed therebetween, it is possible to increase symmetry of the entire internal electrode. As a result, it is possible to cause the residual stress occurring with the shrinkage at the time of baking to be concentrated onto the center and uniform in a plane. As a result, electrical characteristics can be improved.

In addition, the same effects as in the first embodiment can be obtained.

### Modified Example 3-1

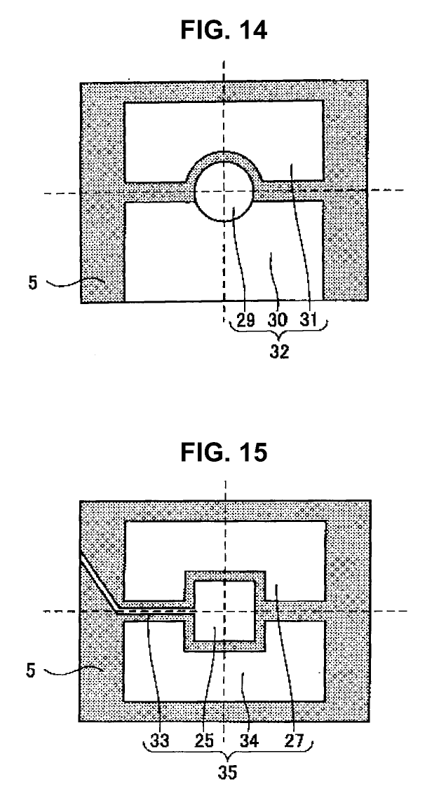

FIG. 14 illustrates a plane configuration of an internal electrode configuring a variable capacitance element according to a modified example 3-1. In FIG. 14, parts corresponding to those of FIG. 2 are denoted by the same reference numerals, and repeated explanation is omitted.

In the variable capacitance element according to the modified example 3-1, an electrode body 29 of an internal electrode 32 has a shape different from that of the third embodiment.

The internal electrode 32 includes the electrode body 29 of a circular shape, a connection electrode 30 that is connected to the side of the electrode body 29, exposed at the side of the variable capacitance element body, and connected to an external terminal, and a floating electrode 31.

The electrode body 29 is formed at almost the center of the dielectric layer 5 such that the center of gravity of the electrode body 29 is aligned with the center of the dielectric layer 5.

The connection electrode 30 is connected to one side of the electrode body 29, and formed to have an end portion that is exposed at the side of the capacitance element body.

The floating electrode 31 is formed in a region at the side opposite to the connection electrode 30 with the electrode body 29 interposed therebetween. Further, the floating electrode 31 has almost the same shape as the connection electrode 30, and is formed to be nearly symmetrical to the connection electrode 30 with respect to an axis passing through the center of gravity of the electrode body 29. Here, the floating electrode 31 is not connected to the electrode body 29, and is formed not to be exposed at the side of the variable capacitance element body. Thus, when the variable capacitance element is driven, external electric potential is not supplied to the floating electrode 31.

In the modified example 3-1, although not shown, a variable capacitance element body is configured by stacking the internal electrodes 32 illustrated in FIG. 14 as two layers such that the side and the center of the electrode body 29 overlap in the stacked direction, and the connection electrodes 30 are exposed at the opposite sides. Further, external terminals that are electrically connected to the respective connection electrodes 30 exposed at the side of the variable capacitance element body are formed, and the variable capacitance element according to the modified example 3-1 is formed. In the modified example 3-1, a capacitor is configured of a pair of electrode bodies 29 that are stacked.

In the modified example 3-1, the floating electrode 31 is formed to be symmetric to the connection electrode 30 with the electrode body 29 interposed therebetween. Thus, the same effects as in the third embodiment can be obtained. In addition, in the modified example 3-1, since the electrode body 29 configuring the capacitor has the circular shape, it is possible to cause residual stress occurring in a plane to be further concentrated on the center.

### Modified Example 3-2

FIG. 15 illustrates a plane configuration of an internal electrode configuring a variable capacitance element according to a modified example 3-2. In FIG. 15, parts corresponding to those of FIG. 13 are denoted by the same reference numerals, and repeated explanation is omitted.

In the modified example 3-2, an internal electrode 35 includes an electrode body 25 having a square shape, a connection electrode 33 that is connected to the side of the electrode body 25, exposed at the side of the variable capacitance element body, and connected to an external terminal, and two floating electrodes 27 and 34. The connection electrode 33 is formed to have a width sufficiently thinner than the width of the electrode body 25. Further, the two floating electrodes 27 and 34 are formed in both regions between which the connection electrode 33 and the electrode body 25 are interposed and symmetric with respect to an axis passing through the center of gravity of the electrode body 25.

In the modified example 3-2, although not shown, a variable capacitance element body is configured by stacking the internal electrodes 35 illustrated in FIG. 15 as two layers such that the side and the center of the electrode body 25 overlap in the stacked direction, and the connection electrodes 33 are exposed at the opposite sides. Further, external terminals that are electrically connected to the respective connection electrodes 33 exposed at the side of the variable capacitance element body are formed, and the variable capacitance element according to the modified example 3-2 is formed. In the modified example 3-2, a capacitor is configured of a pair of electrode bodies 25 that are stacked.

In the modified example 3-2, since the connection electrode 33 is formed with the width sufficiently smaller than the width of the electrode body 25, it is possible to reduce residual stress occurring in the connection electrode 33. Further, in the modified example 3-2, as the floating electrodes 27 and 34 that do not form the capacitance are symmetrically formed in both regions between which the electrode body 25 is interposed, it is possible to increase residual stress occurring at the center of the capacitor. Thus, it is possible to improve the electrical characteristics of the variable capacitance element. In addition, the same effects as in the third embodiment can be obtained.

### Modified Example 3-3

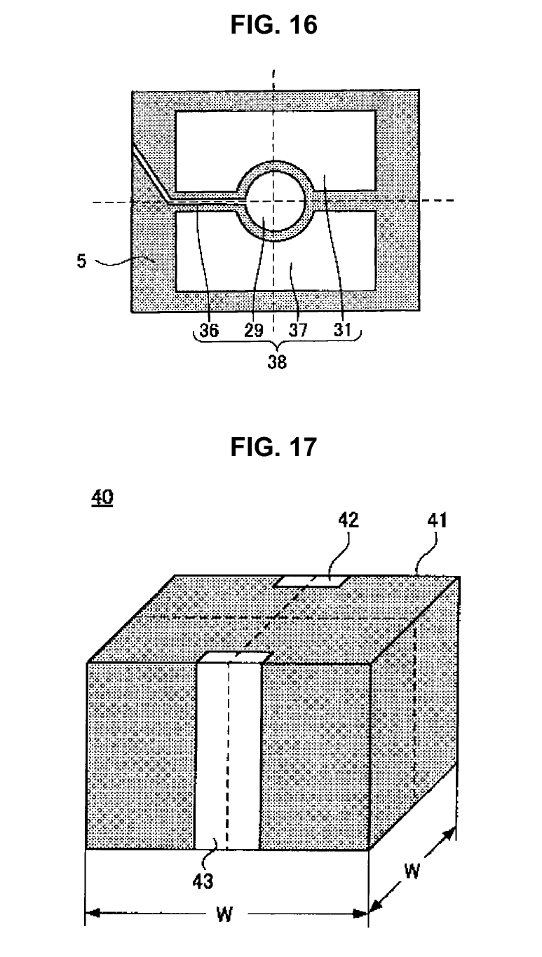

FIG. 16 illustrates a plane configuration of an internal electrode configuring a variable capacitance element according to a modified example 3-3. In FIG. 16, parts corresponding to those of FIG. 14 are denoted by the same reference numerals, and repeated explanation is omitted.

In the modified example 3-3, an internal electrode 38 includes an electrode body 29 having a circular shape, a connection electrode 36 that is connected to the side of the electrode body 29, exposed at the side of the variable capacitance element body, and connected to an external terminal, and two floating electrodes 31 and 37. The connection electrode 36 is formed to have a width sufficiently thinner than the diameter of the electrode body 29. Further, the two floating electrodes 31 and 37 are formed in both regions between which the connection electrode 36 and the electrode body 29 are interposed and symmetric with respect to an axis passing through the center of gravity of the electrode body 29.

In the modified example 3-3, although not shown, a variable capacitance element body is configured by stacking the internal electrodes 38 illustrated in FIG. 16 as two layers such that the side and the center of the electrode body 29 overlap in the stacked direction, and the connection electrodes 36 are exposed at the opposite sides. Further, external terminals that are electrically connected to the respective connection electrodes 36 exposed at the side of the variable capacitance element body are formed, and the variable capacitance element according to the modified example 3-3 is formed. In the modified example 3-3, a capacitor is configured of a pair of electrode bodies 29 that are stacked.

In the modified example 3-3, since the connection electrode 36 is formed with the width sufficiently smaller than the width of the electrode body 25, it is possible to reduce residual stress occurring in the connection electrode 36. Further, in the modified example 3-3, as the floating electrodes 31 and 37 that do not form the capacitance are symmetrically formed in both regions between which the electrode body 29 is interposed, it is possible to increase residual stress occurring at the center of the capacitor. Thus, it is possible to improve the electrical characteristics of the variable capacitance element. In addition, the same effects as in the third embodiment can be obtained.

### 4. Fourth Embodiment

Next, a variable capacitance element according to a fourth embodiment of the present disclosure will be described. The present embodiment is different from the first embodiment in the shape of the variable capacitance element body, but has the same shape and cross-sectional configuration of the internal electrode as the variable capacitance element of the first embodiment illustrated in FIG. 1, and thus illustration thereof is omitted.

FIG. 17 is a perspective view of an external appearance of the variable capacitance element according to the present embodiment.

As illustrated in FIG. 17, a variable capacitance element 40 according to the present embodiment includes a variable capacitance element body 41 and two external terminals 42 and 43. The variable capacitance element body 41 has a rectangular parallelepiped shape (or a cubic shape) in which a plane shape parallel to a plane on which an internal electrode is formed is a square shape. In other words, in the present embodiment, the square shape is configured such that the plane shape parallel to the plane on which the internal electrode is formed has a horizontal width W and a vertical width W as illustrated in FIG. 17.

In the variable capacitance element 40 according to the present embodiment, since the plane on which the internal electrode is formed has the square shape, symmetry of the shape of the variable capacitance element body 41 is high. The residual stress occurring at the time of baking of the variable capacitance element body 41 occurs due to the difference in the shrinkage rate (linear expansion coefficient) between the electrode material and the dielectric material. Thus, it is possible to improve symmetry of the internal electrode and symmetry of the shape of the variable capacitance element body 41, and it is possible to cause the residual stress to be further concentrated on the center. Thus, it is possible to improve the electrical characteristics of the capacitor formed by the internal electrodes.

In addition, the same effects as in the first embodiment can be obtained.

### Modified Example 4-1

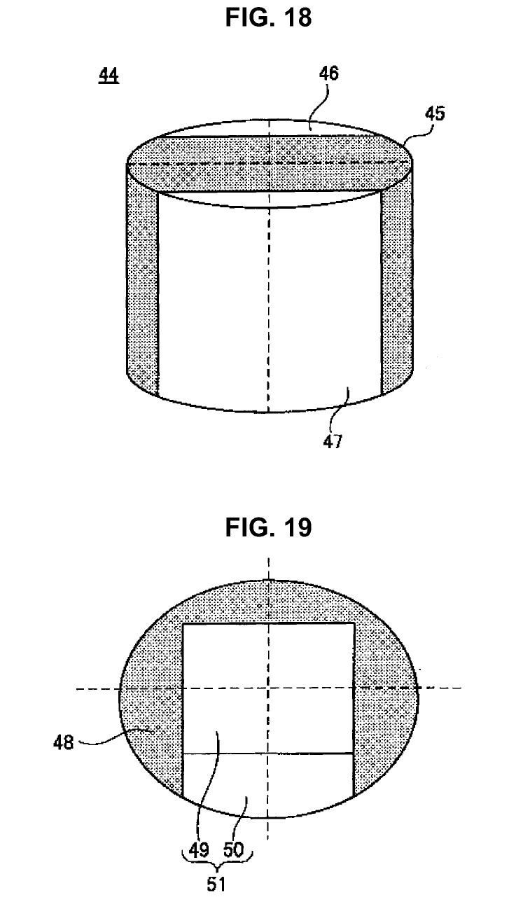

FIG. 18 is a perspective view of an external appearance illustrating a variable capacitance element according to the modified example 4-1. The modified example 4-1 is different from the first embodiment in the shape of the variable capacitance element body, but has the same shape and cross-sectional configuration of the internal electrode as the variable capacitance element of the first embodiment illustrated in FIG. 1, and thus illustration thereof is omitted.

As illustrated in FIG. 17, a variable capacitance element 44 according to the modified example 4-1 includes a variable capacitance element body 45 and two external terminals 46 and 47. The variable capacitance element body 45 has a circular cylindrical shape in which a plane shape parallel to a plane on which an internal electrode is formed is a circular shape.

In the modified example 4-1, since the variable capacitance element body 45 is formed in the circular cylindrical shape, symmetry of the shape of the variable capacitance element body 45 with respect to a straight line passing through the center of the electrode body of the internal electrode in the stacked direction is high. Thus, it is possible to further increase residual stress occurring in the variable capacitance element body 45, and the same effects as in the fourth embodiment can be obtained.

### Modified Example 4-2

FIG. 19 illustrates a plane configuration of a dielectric layer and an internal electrode configuring a variable capacitance element according to a modified example 4-2. In the variable capacitance element according to the modified example 4-2, an internal electrode 51 includes an electrode body 49 having a square shape and a connection electrode 50 that is connected to one side of the electrode body 49 and is formed such that an end portion is exposed at the side of the capacitance element body. Further, a shape of a plane on which the internal electrode 51 of the variable capacitance element body is formed, that is, a plane shape of a dielectric layer 48, is an elliptical shape, and the connection electrode 50 configuring the internal electrode 51 is formed in the short diameter direction of the dielectric layer 48 of the elliptical shape.

In the modified example 4-2, although not shown, a variable capacitance element body is configured by stacking the internal electrodes 51 illustrated in FIG. 19 as two layers such that the side and the center of the electrode body 49 overlap in the stacked direction, and the connection electrodes 50 are exposed at the opposite sides. Further, external terminals that are electrically connected to the respective connection electrodes 50 exposed at the side of the variable capacitance element body are formed, and the variable capacitance element according to the modified example 4-2 is formed. In the modified example 4-2, a capacitor is configured of a pair of electrode bodies 49 that are stacked.

In the modified example 4-2, since the variable capacitance element body has the columnar shape having the cross section of an elliptical shape, it is possible to increase symmetry of the shape of the variable capacitance element body, and the same effects as in the fourth embodiment can be obtained.

### Modified Example 4-3

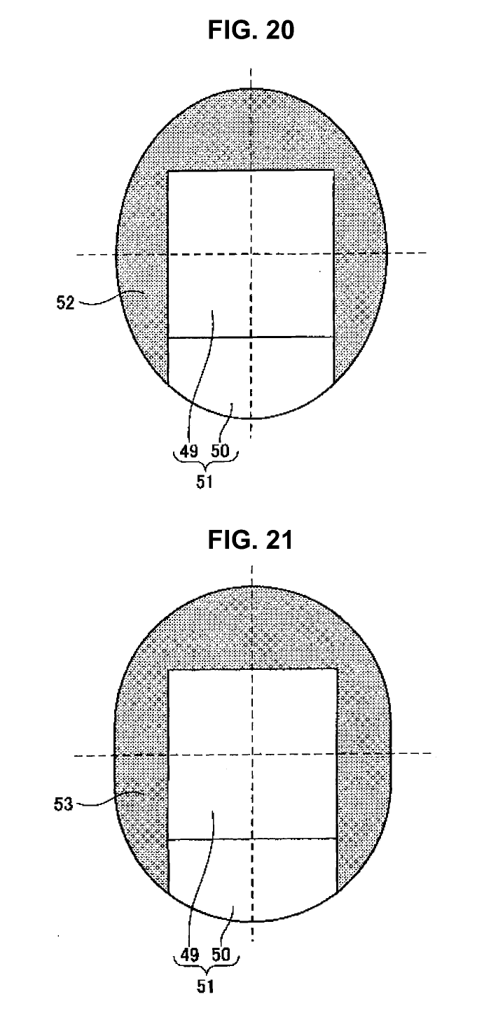

FIG. 20 illustrates a plane configuration of a dielectric layer and an internal electrode configuring a variable capacitance element according to a modified example 4-3. The variable capacitance element according to the modified example 4-3 is the same in an internal electrode 51 as in the modified example 4-2. Further, a shape of a plane on which the internal electrode 51 of the variable capacitance element body is formed, that is, a plane shape of a dielectric layer 52, is an elliptical shape, and a connection electrode 50 configuring the internal electrode 51 is formed in the long diameter direction of the dielectric layer 52 of the elliptical shape.

In the modified example 4-3, although not shown, a variable capacitance element body is configured by stacking the internal electrodes 51 illustrated in FIG. 20 as two layers such that the side and the center of the electrode body 49 overlap in the stacked direction, and the connection electrodes 50 are exposed at the opposite sides. Further, external terminals that are electrically connected to the respective connection electrodes 50 exposed at the side of the variable capacitance element body are formed, and the variable capacitance element according to the modified example 4-3 is formed. In the modified example 4-3, a capacitor is configured of a pair of electrode bodies 49 that are stacked.

In the modified example 4-3, since the variable capacitance element body has the columnar shape having the cross section of an elliptical shape, it is possible to increase symmetry of the shape of the variable capacitance element body, and the same effects as in the fourth embodiment can be obtained.

### Modified Example 4-4

FIG. 21 illustrates a plane configuration of a dielectric layer and an internal electrode configuring a variable capacitance element according to a modified example 4-4. The variable capacitance element according to the modified example 4-4 is the same in an internal electrode 51 as in the modified example 4-2. Further, a shape of a plane on which the internal electrode 51 of the variable capacitance element body is formed, that is, a plane shape of a dielectric layer 53, is a rounded rectangular shape (an oval shape), and a connection electrode 50 configuring the internal electrode 51 is formed in the long diameter direction of the dielectric layer 53 of the rounded rectangular shape.

In the modified example 4-4, although not shown, a variable capacitance element body is configured by stacking the internal electrodes 51 illustrated in FIG. 21 as two layers such that the side and the center of the electrode body 49 overlap in the stacked direction, and the connection electrodes 50 are exposed at the opposite sides. Further, external terminals that are electrically connected to the respective connection electrodes 50 exposed at the side of the variable capacitance element body are formed, and the variable capacitance element according to the modified example 4-4 is formed. In the modified example 4-4, a capacitor is configured of a pair of electrode bodies 49 that are stacked.

In the modified example 4-4, since the variable capacitance element body has the columnar shape having the cross section of the oval shape, it is possible to increase symmetry of the shape of the variable capacitance element body, and the same effects as in the fourth embodiment can be obtained.

### Modified Example 4-5

FIG. 22 illustrates a plane configuration of a dielectric layer and an internal electrode configuring a variable capacitance element according to a modified example 4-5. The variable capacitance element according to the modified example 4-5 is the same in an internal electrode 51 as in the modified example 4-2. Further, a shape of a plane on which the internal electrode of the variable capacitance element body is formed, that is, a plane shape of a dielectric layer, is a quadrangular shape in which two corners positioned at both sides of one side of a square shape are rounded.

In the modified example 4-5, although not shown, a variable capacitance element body is configured by stacking the internal electrodes illustrated in FIG. 22 such that the side and the center of the electrode body overlap in the stacked direction, and the connection electrodes are exposed at the opposite sides. Further, external terminals that are electrically connected to the respective connection electrodes exposed at the side of the variable capacitance element body are formed, and the variable capacitance element according to the modified example 4-5 is formed. In the modified example 4-5, a capacitor is configured of the stacked electrode bodies 49 having the square shape.

In the modified example 4-5, since the variable capacitance element body has the rectangular columnar shape in which the corners of one side are rounded, it is possible to increase symmetry of the plane shape of the dielectric layer and symmetry of the variable capacitance element body, and the same effects as in the fourth embodiment can be obtained.

### Modified Example 4-6

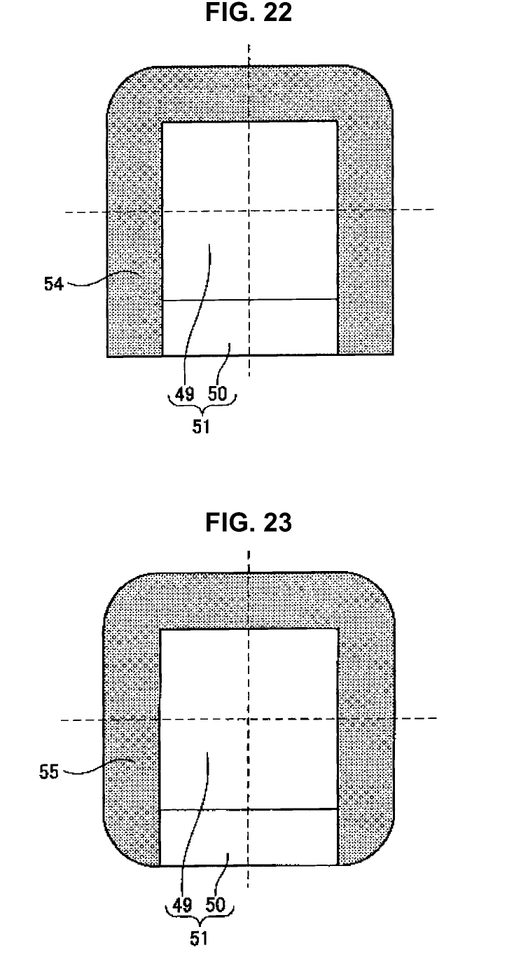

FIG. 23 illustrates a plane configuration of a dielectric layer and an internal electrode configuring a variable capacitance element according to a modified example 4-6. The variable capacitance element according to the modified example 4-6 is the same in an internal electrode 51 as in the modified example 4-2. Further, a shape of a plane on which the internal electrode 51 of the variable capacitance element body is formed, that is, a plane shape of a dielectric layer 55, is a rounded square shape in which four corners of the square shape are rounded.

In the modified example 4-6, although not shown, a variable capacitance element body is configured by stacking the internal electrodes 51 illustrated in FIG. 23 as two layers such that the side and the center of the electrode body 49 overlap in the stacked direction, and the connection electrodes 50 are exposed at the opposite sides. Further, external terminals that are electrically connected to the respective connection electrodes 50 exposed at the side of the variable capacitance element body are formed, and the variable capacitance element according to the modified example 4-6 is formed. In the modified example 4-6, a capacitor is configured of a pair of electrode bodies 49 that are stacked.

In the modified example 4-6, since the variable capacitance element body is formed in the columnar shape having the cross section of the rounded square shape, it is possible to increase symmetry of the variable capacitance element body, and the same effects as in the fourth embodiment can be obtained.

### Modified Example 4-7

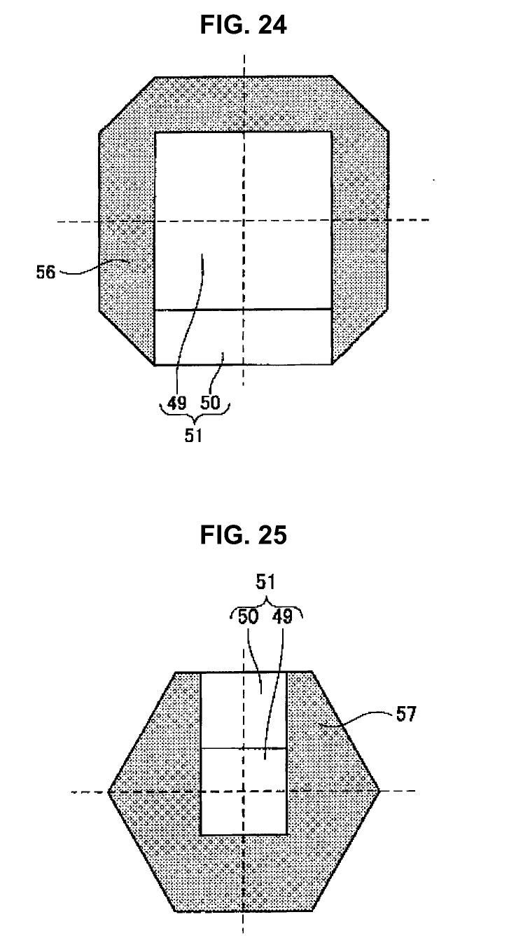

FIG. 24 illustrates a plane configuration of a dielectric layer and an internal electrode configuring a variable capacitance element according to a modified example 4-7. The variable capacitance element according to the modified example 4-7 is the same in an internal electrode 51 as in the modified example 4-2. Further, a shape of a plane on which the internal electrode 51 of the variable capacitance element body is formed, that is, a plane shape of a dielectric layer 56, is an octagonal shape.

In the modified example 4-7, although not shown, a variable capacitance element body is configured by stacking the internal electrodes 51 illustrated in FIG. 24 as two layers such that the side and the center of the electrode body overlap in the stacked direction, and the connection electrodes 50 are exposed at the opposite sides. Further, external terminals that are electrically connected to the respective connection electrodes 50 exposed at the side of the variable capacitance element body are formed, and the variable capacitance element according to the modified example 4-7 is formed. In the modified example 4-7, a capacitor is configured of a pair of electrode bodies 49 that are stacked.

In the modified example 4-7, since the variable capacitance element body is formed in the columnar shape having the cross section of the octagonal shape, it is possible to increase symmetry of the shape of the variable capacitance element body, and the same effects as in the fourth embodiment can be obtained.

### Modified Example 4-8

FIG. 25 illustrates a plane configuration of a dielectric layer and an internal electrode configuring a variable capacitance element according to a modified example 4-8. The variable capacitance element according to the modified example 4-8 is the same in an internal electrode 51 as the modified example 4-2. Further, a shape of a plane on which the internal electrode 51 of the variable capacitance element body is formed, that is, a plane shape of a dielectric layer 57, is a regular hexagonal shape.

In the modified example 4-8, although not shown, a variable capacitance element body is configured by stacking the internal electrodes 51 illustrated in FIG. 25 as two layers such that the side and the center of the electrode body 49 overlap in the stacked direction, and the connection electrodes 50 are exposed at the opposite sides. Further, external terminals that are electrically connected to the respective connection electrodes 50 exposed at the side of the variable capacitance element body are formed, and the variable capacitance element according to the modified example 4-8 is formed. In the modified example 4-8, a capacitor is configured of a pair of electrode bodies 49 that are stacked.

In the modified example 4-8, since the variable capacitance element body is formed in the columnar shape having the cross section of the regular hexagonal shape, it is possible to increase symmetry of the shape of the variable capacitance element body, and the same effects as in the fourth embodiment can be obtained.

### 5. Fifth Embodiment

Next, a variable capacitance element according to a fifth embodiment of the present disclosure will be described. FIG. 26 is a plane configuration view illustrating a dielectric layer and an internal electrode configuring the variable capacitance element according to the present embodiment. The present embodiment is different from the first embodiment in the shape of the variable capacitance element body. In FIG. 26, parts corresponding to those of FIG. 2 are denoted by the same reference numerals, and repeated explanation is omitted.

In the variable capacitance element according to the present embodiment, an internal electrode 10 includes an electrode body 8 of a circular shape and a connection electrode 9 that is connected to one side of the electrode body 8 and formed such that an end portion thereof is exposed at the side of the capacitance element body. Further, a shape of a plane on which the internal electrode 10 of the variable capacitance element body is formed, that is, a plane shape of a dielectric layer 58, is a circular shape. Further, the center of gravity of the electrode body 8 of the internal electrode 10 is positioned at the center of the dielectric layer 58.

In the present embodiment, although not shown, a variable capacitance element body is configured by stacking the internal electrodes 10 illustrated in FIG. 26 as two layers such that the side and the center of the electrode body 8 overlap in the stacked direction, and the connection electrodes 9 are exposed at the opposite sides. Further, external terminals that are electrically connected to the respective connection electrodes 9 exposed at the side of the variable capacitance element body are formed, and the variable capacitance element according to the present embodiment is formed. In the present embodiment, a capacitor is configured of a pair of electrode bodies 8 that are stacked.

In the present embodiment, since the shape of the electrode body 8 configuring the capacitance of the internal electrode 10 is the same as the plane shape of the dielectric layer 58, symmetry of the shape of the electrode body 8 and the variable capacitance element body is high. Thus, it is possible to cause the residual stress occurring at the time of baking of the variable capacitance element body to be further concentrated in the center direction, and it is possible to improve the electrical characteristics of the capacitor configured of a pair of electrode bodies 8.

In addition, the same effects as in the first embodiment can be obtained.

### Modified Example 5-1

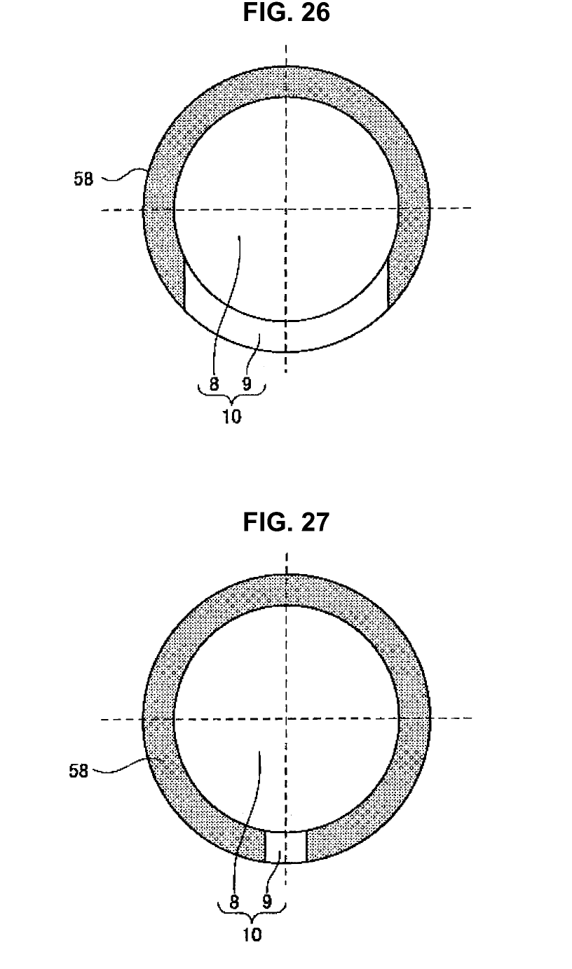

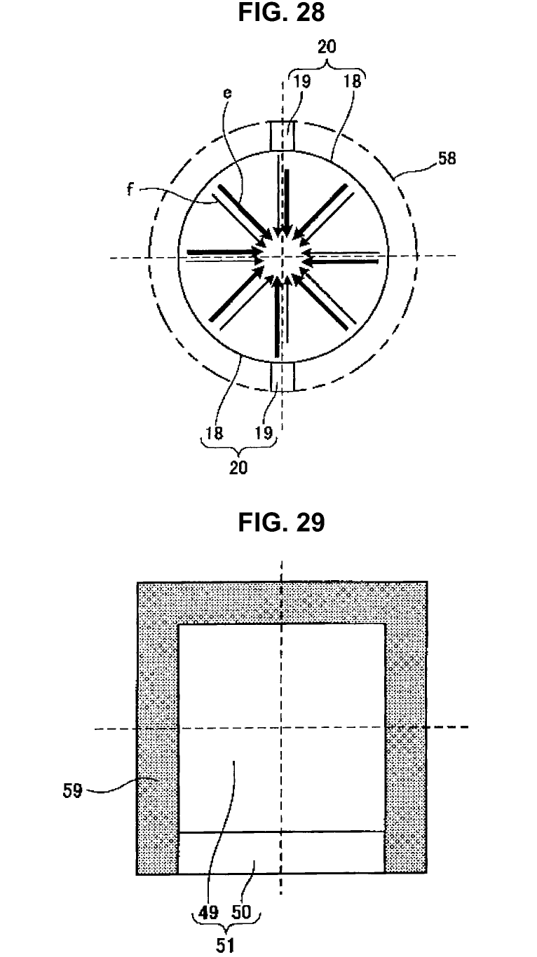

FIG. 27 illustrates a plane configuration of a dielectric layer and an internal electrode configuring a variable capacitance element according to a modified example 5-1. In FIG. 27, parts corresponding to those of FIG. 26 are denoted by the same reference numerals, and repeated explanation is omitted. In the variable capacitance element according to the modified example 5-1, an internal electrode 20 has the same configuration of the internal electrode 20 of the second embodiment.

In the modified example 501, although not shown, a variable capacitance element body is configured by stacking the internal electrodes illustrated in FIG. 27 as two layers such that the side and the center of gravity of the electrode body 8 overlap in the stacked direction, and the connection electrodes 19 are exposed at the opposite sides. Further, external terminals that are electrically connected to the respective connection electrodes 19 exposed at almost the center of the variable capacitance element body in the long axis direction are formed, and the variable capacitance element according to the modified example 5-1 is formed. In the modified example 5-1, a capacitor is configured of a pair of electrode bodies 8 that are stacked.

In the modified example 5-1, in the internal electrode 20, the connection electrode 19 connected to the electrode body 8 is formed to have an area size sufficiently smaller than the electrode body 8. Thus, a dielectric layer 58 and the internal electrode 20 can be approximated to a relation of a similar shape.

FIG. 28 is a plane view illustrating the two internal electrodes 20 of the variable capacitance element 1 according to the modified example 5-1 when the inside is viewed from above. In FIG. 28, residual stress occurring in the internal electrode 20 of the lower layer is indicated by an arrow e, and residual stress occurring in the internal electrode 20 of the upper layer is indicated by an arrow f.

As illustrated in FIG. 28, in the modified example 5-1, since the connection electrode 19 is formed to have the area size sufficiently smaller than the electrode body 8, contribution to the residual stress occurring in the connection electrode 19 is reduced. Thus, compared to the internal electrode 10 of the first embodiment in which the connection electrode 9 is formed to have the width that is almost equal to the diameter of the electrode body 8, residual stress occurring toward the center of the electrode body 8 becomes uniform throughout the whole surface. As a result, tensile stress in the stacked direction (electric field direction) of the internal electrode 20 further increases, and the electrical characteristics of the capacitor are improved.

Further, in the modified example 5-1, since the shape of the electrode body 8 configuring the capacitance of the internal electrode 20 is the same as the plane shape of the dielectric layer 58, symmetry of the shape of the electrode body 8 and the variable capacitance element body is high, and the same effects as in the fifth embodiment can be obtained.

### Modified Example 5-2

FIG. 29 illustrates a plane configuration of a dielectric layer and an internal electrode configuring a variable capacitance element according to a modified example 5-2. In the modified example 5-2, an internal electrode 51 includes an electrode body 49 having a square shape and a connection electrode 50 that is connected to one side of the electrode body 49 and is formed such that an end portion is exposed at the side of the capacitance element body. Further, a shape of a plane on which the internal electrode 51 of the variable capacitance element body is formed, that is, a plane shape of a dielectric layer 59, is a square shape. Further, the center of gravity of the electrode body 49 of the internal electrode 51 is positioned at the center of the dielectric layer 59.

In the modified example 5-2, although not shown, a variable capacitance element body is configured by stacking the internal electrodes 51 illustrated in FIG. 29 as two layers such that the side and the center of the electrode body 49 overlap in the stacked direction, and the connection electrodes 50 are exposed at the opposite sides. Further, external terminals that are electrically connected to the respective connection electrodes exposed at the side of the variable capacitance element body are formed, and the variable capacitance element according to the modified example 5-2 is formed. In the modified example 5-2, a capacitor is configured of a pair of electrode bodies 49 that are stacked.

In the modified example 5-2, since the shape of the electrode body 49 configuring the capacitance of the internal electrode 51 is the same as the plane shape of the dielectric layer 59, symmetry of the shape of the electrode body 49 and the variable capacitance element body is high, and the same effects as in the fifth embodiment can be obtained.

### Modified Example 5-3

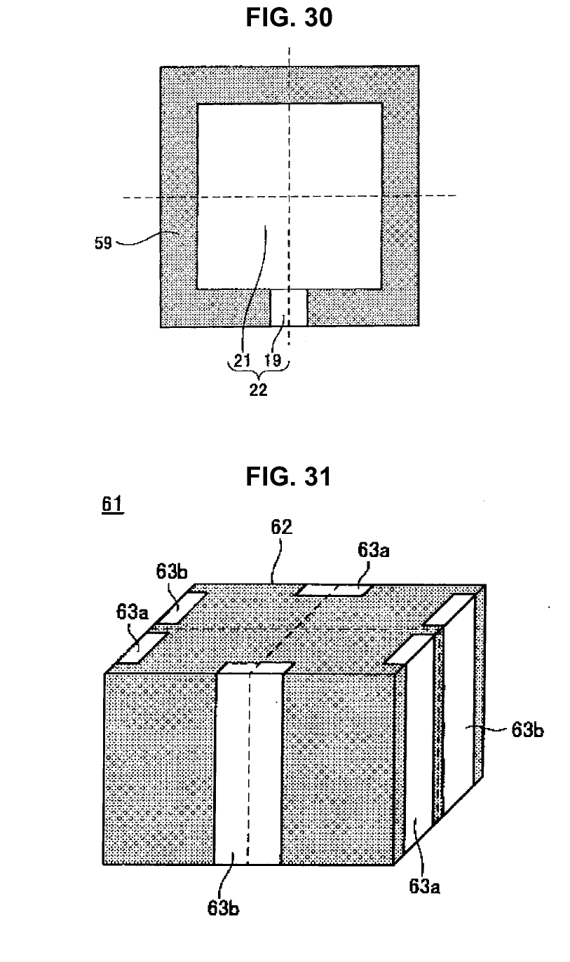

FIG. 30 illustrates a plane configuration of a dielectric layer and an internal electrode configuring a variable capacitance element according to a modified example 5-3. In FIG. 30, parts corresponding to those of FIG. 29 are denoted by the same reference numerals, and repeated explanation is omitted. In the variable capacitance element according to the modified example 5-3, the internal electrode 22 has the same configuration as the internal electrode 22 of the modified example 2-1 illustrated in FIG. 11.

In the modified example 5-3, although not shown, a variable capacitance element body is configured by stacking the internal electrodes 22 illustrated in FIG. 30 as two layers such that the side and the center of gravity of the electrode body 21 overlap in the stacked direction, and the connection electrodes 19 are exposed at the opposite sides. Further, external terminals that are electrically connected to the respective connection electrodes 19 exposed at the side of the variable capacitance element body are formed, and the variable capacitance element according to the modified example 5-3 is formed. In the modified example 5-3, a capacitor is configured of the stacked electrode bodies of the circular shape.

In the modified example 5-3, in the internal electrode 22, the connection electrode 19 connected to the electrode body 21 is formed to have an area size sufficiently smaller than the electrode body 21. Thus, a dielectric layer 59 and the internal electrode 22 can be approximated to a relation of a similar shape. Thus, it is possible to cause residual stress occurring at the time of baking of the variable capacitance element body to be further concentrated toward the center, and it is possible to improve the electrical characteristics of the capacitor.

In addition, the same effects as in the fifth embodiment can be obtained.

### 6. Sixth Embodiment

### Three Terminals

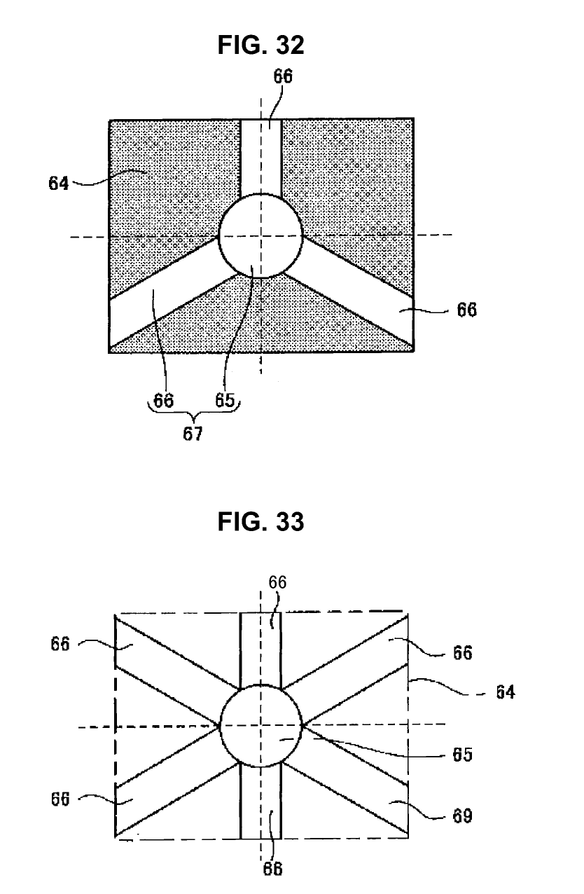

Next, a variable capacitance element according to a sixth embodiment of the present disclosure will be described. FIG. 31 is a perspective view illustrating the variable capacitance element according to the present embodiment. FIG. 32 is a plane configuration view illustrating an internal electrode configuring the variable capacitance element according to the present embodiment.

As illustrated in FIG. 31, the variable capacitance element according to the present embodiment includes a variable capacitance element body 62 configured with a rectangular parallelepiped member and three external terminals 63a and three external terminals 63b. The external terminals 63a and 63b are formed apart from each other at the sides of the variable capacitance element body. Although not shown, the variable capacitance element body 62 is configured by stacking two internal electrodes 67 illustrated in FIG. 32.

In the present embodiment, the internal electrode 67 includes an electrode body 65 having a circular shape and three connection electrodes 66 that are connected to the electrode body 65 and formed at equal intervals in the circumferential direction of the electrode body 65 as illustrated in FIG. 32. A plane of a dielectric layer 64 on which the internal electrode 67 is formed has a rectangular shape.

Further, in the present embodiment, each of the three connection electrodes 66 is formed in the form of a band thinner than the diameter of the electrode body 65 and exposed at the side of the variable capacitance element body 62. Further, when the internal electrode 67 illustrated in FIG. 32 and the internal electrode 67 in the state in which the internal electrode 67 illustrated in FIG. 32 is rotated 180 degrees on an axis perpendicular to the electrode plane are stacked, the connection electrodes 66 are formed not to overlap each other in the stacked direction.

In the present embodiment, the variable capacitance element body can be configured by stacking the internal electrode 67 illustrated in FIG. 32 and the internal electrode 67 in the state in which the internal electrode 67 illustrated in FIG. 32 is rotated 180 degrees on an axis perpendicular to the electrode plane. FIG. 33 is a diagram illustrating the variable capacitance element body 62 according to the present embodiment when the inside is viewed from above.

As illustrated in FIG. 33, a total of six connection electrodes 66 formed on the stacked two internal electrodes 32 do not overlap each other in the stacked direction. For this reason, in the present embodiment, the capacitance is not formed between the stacked connection electrodes 66, and the capacitor is configured with the electrode bodies 65 overlapping each other in the stacked direction. Then, the external terminals 63a and 63b that are connected to the six connection electrodes 66 exposed at the sides of the variable capacitance element body 62 according to the present embodiment are formed, and thus the variable capacitance element 61 according to the present embodiment is formed.

In the present embodiment, by increasing the number of the connection electrodes 66 connected to one electrode body 65, it is possible to improve a withstand voltage on an input signal voltage.

Further, in the present embodiment, the electrode body 65 forming the capacitor has the circular shape, and the connection electrodes 66 connected to the electrode body 65 are formed at equal intervals in the three directions, and thus it is possible to increase symmetry of the internal electrode 67 As a result, it is possible to cause residual stress occurring at the time of baking of the variable capacitance element body 62 to be concentrated toward the center, and it is possible to improve the electrical characteristics of the capacitor.

In addition, the same effects as in the first embodiment can be obtained.

### Modified Example 6-1

FIG. 34 illustrates a plane configuration of a dielectric layer and an internal electrode configuring a variable capacitance element according to a modified example 6-1. In FIG. 34, parts corresponding to those of FIG. 32 are denoted by the same reference numerals, and repeated explanation is omitted. In the modified example 6-1, an internal electrode 70 includes an electrode body 65 of a circular shape and three connection electrodes 69 that are connected to the electrode body 65 and formed at equal intervals in the circumferential direction of the electrode body 65. A plane of a dielectric layer 68 on which the internal electrode 70 is formed has a square shape.

Further, in the modified example 6-1, each of the three connection electrodes 69 is formed such that the width increases from the side connected to the electrode body 65 toward the end portion side exposed at the side of the variable capacitance element body. Further, when the internal electrode 70 illustrated in FIG. 34 and the internal electrode 70 in the state in which the internal electrode 67 illustrated in FIG. 32 is rotated 180 degrees on an axis perpendicular to the electrode plane are stacked, the connection electrodes 69 are formed not to overlap each other in the stacked direction.

In the modified example 6-1, the variable capacitance element body can be configured by stacking the internal electrode 70 illustrated in FIG. 34 and the internal electrode 70 in the state in which the internal electrode 70 illustrated in FIG. 34 is rotated 180 degrees on an axis vertical to the electrode plane. Thus, a total of six connection electrodes 69 formed on the two stacked internal electrodes 70 are exposed at the sides without overlapping each other in the stacked direction. Further, because the connection electrodes 69 that are formed in the stacked direction do not overlap in the stacked direction, no capacitance is formed between the stacked connection electrodes 69. Therefore, external terminals that are connected to the six connection electrodes 69 exposed at the sides of the variable capacitance element body are formed, and thus the variable capacitance element according to the modified example 6-1 is formed.

In the modified example 6-1, the connection electrode 69 is formed such that the width thereof increases toward the side connected to the external terminal. For this reason, the withstand voltage can be improved compared to the variable capacitance element 61 according to the sixth embodiment. In addition, the same effects as in the sixth embodiment can be obtained.

### Modified Example 6-2

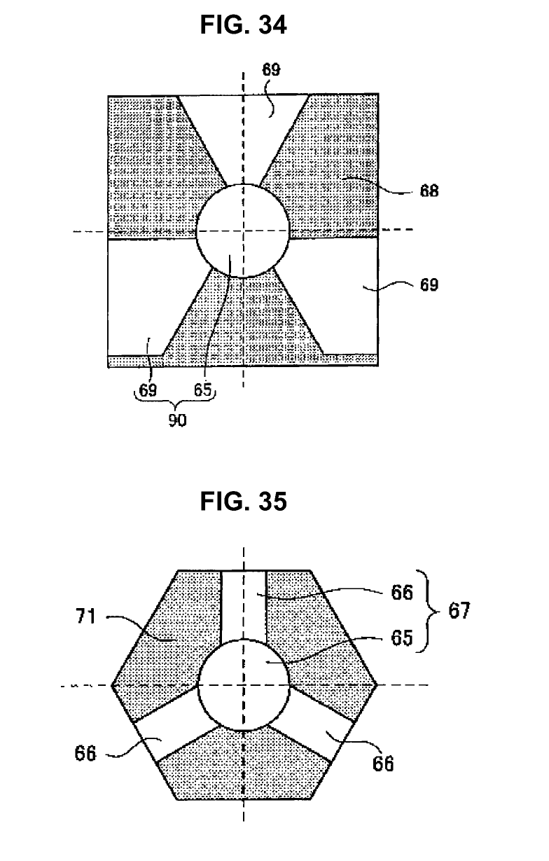

FIG. 35 illustrates a plane configuration of a dielectric layer and an internal electrode configuring a variable capacitance element according to a modified example 6-2. In FIG. 35, parts corresponding to those of FIG. 32 are denoted by the same reference numerals, and repeated explanation is omitted. The modified example 6-2 is different from the sixth embodiment in a plane shape of a dielectric layer.

In the modified example 6-2, a dielectric layer 71 has a plane shape of a regular hexagonal shape. Further, three connection electrodes 66 are formed to be exposed at the sides of the dielectric layer 71 of the regular hexagonal shape in an alternate manner. In the modified example 6-2, the variable capacitance element body can be configured by stacking the internal electrode 67 illustrated in FIG. 35 and the internal electrode 67 in the state in which the internal electrode 67 illustrated in FIG. 35 is rotated 180 degrees on an axis vertical to the electrode plane. Then, external terminals that are connected to the six connection electrodes 66 exposed at the sides of the variable capacitance element body are formed, and thus the variable capacitance element according to the modified example 6-2 is formed. At this time, the variable capacitance element body is formed in a columnar shape in which a cross section has a regular hexagonal shape.

In the variable capacitance element according to the modified example 6-2, symmetry of the shape of the internal electrode 67 and the variable capacitance element body is high, it is possible to further increase residual stress occurring at the time of baking of the variable capacitance element body, and the same effects as in the sixth embodiment can be obtained.

The variable capacitance elements according to the first to sixth embodiments and the variable capacitance elements according to the modified examples have been described above in connection with the example in which the stacked internal electrodes have the same shape. However, the present disclosure is not limited to this example, and even when internal electrodes of different shapes are combined and stacked, an effect of an improvement in electrical characteristics resulting from an increase in residual stress is obtained. When the electrode bodies of the stacked internal electrodes have the same shape as in the first to sixth embodiments, electrical characteristics are further improved.

Configurations of variable capacitance elements obtained by combining and stacking internal electrodes of different shapes based on the shapes of the internal electrodes and the plane shapes of the dielectric layer according to the above embodiments will be described below. The following embodiments will be described in connection with an example of a variable capacitance element including a plurality of capacitors that are connected in series in a stacked direction of internal electrodes.

### 7. Seventh Embodiment

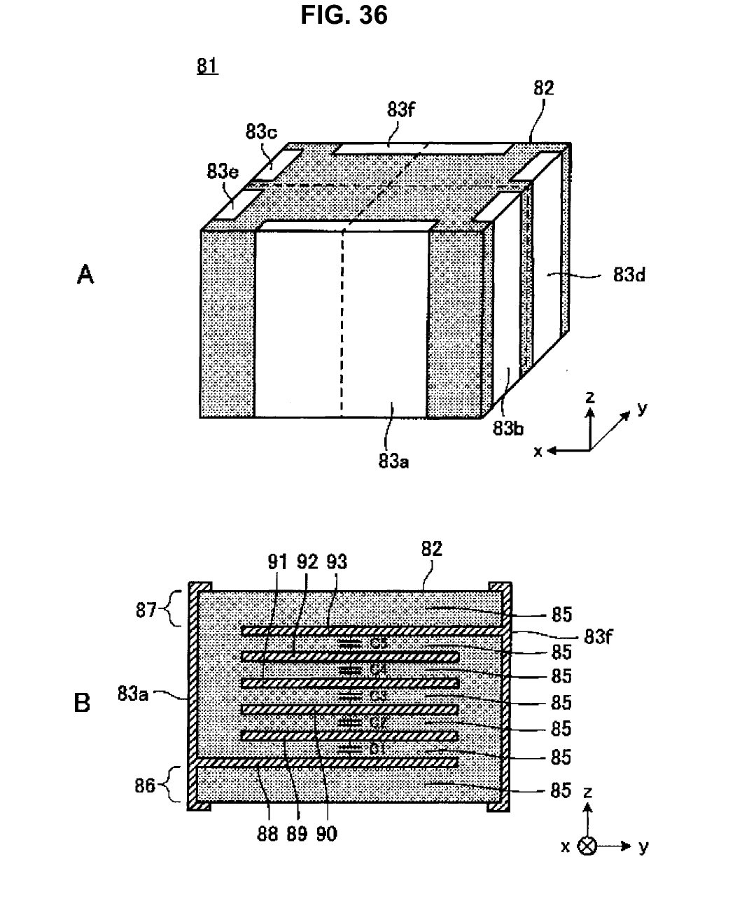

FIG. 36A is a schematic perspective view illustrating a variable capacitance element 81 according to a seventh embodiment of the present disclosure, and FIG. 36B is a cross-sectional configuration view illustrating the variable capacitance element 81. In the following, a stacked direction of an internal electrode to be described later is referred to as a “z direction,” one direction of the variable capacitance element 81 perpendicular to the stacked direction is referred to as an “x direction,” and the other direction of the variable capacitance element 81 perpendicular to the stacked direction is referred to as a “y direction.” Further, one plane configured with an xy plane of the variable capacitance element 81 is referred to as an “upper surface,” and the other plane configured with an xy plane is referred to as a “lower surface.” Further, a plane perpendicular to the upper surface and the lower surface of the variable capacitance element 1 is referred to as a “side surface.”

As illustrated in FIG. 36A, the variable capacitance element 1 according to the present embodiment includes a variable capacitance element body 82 configured with a rectangular parallelepiped member having an xy plane of a square shape and six external terminals (hereinafter referred to as “first to sixth external terminals 83a to 83f”).

The first external terminal 83a is formed on one side surface configured with a yz plane of the variable capacitance element body 82, and the sixth external terminal 83f is formed on the other side surface configured with the yz plane of the variable capacitance element body 82. The second external terminal 83b and the fourth external terminal 83d are formed apart from each other on one side surface configured with an xz plane of the variable capacitance element body 82, and the third external terminal 83c and the fifth external terminal 83e are formed apart from each other on the other side surface configured with the xz plane of the variable capacitance element body 82. Further, when viewed on the xy plane, the second external terminal 83b and the third external terminal 83c are positioned at opposite angles, and the fourth external terminal 83d and the fifth external terminal 83e are positioned at opposite angles.

Further, the first external terminal 83a to the sixth external terminal 83f are formed to cover the side surfaces of the variable capacitance element body 82 in the z direction and to extend beyond the upper surface and the lower surface of the variable capacitance element body 82.

The variable capacitance element body 82 includes a dielectric layer 85 and six internal electrodes 88 to 93 stacked with the dielectric layer 85 interposed therebetween as illustrated in FIG. 36B. In the following description, for convenience, the six internal electrodes are referred to as “first to sixth internal electrodes 88 to 93.” The variable capacitance element body 82 according to the present embodiment is configured by stacking the first internal electrode 88 to the sixth internal electrode 93 in order from a lower surface to an upper surface. Further, a lower dielectric layer 86 is stacked as a layer below the first internal electrode 88, and an upper dielectric layer 87 is stacked as a layer above the sixth internal electrode 93.

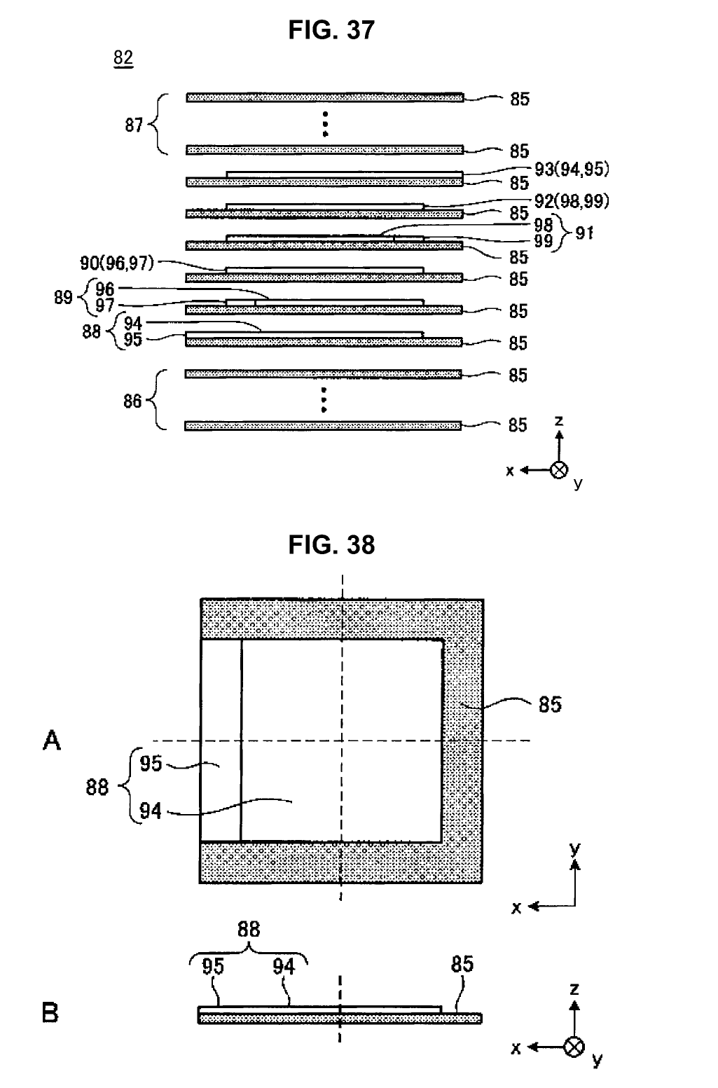

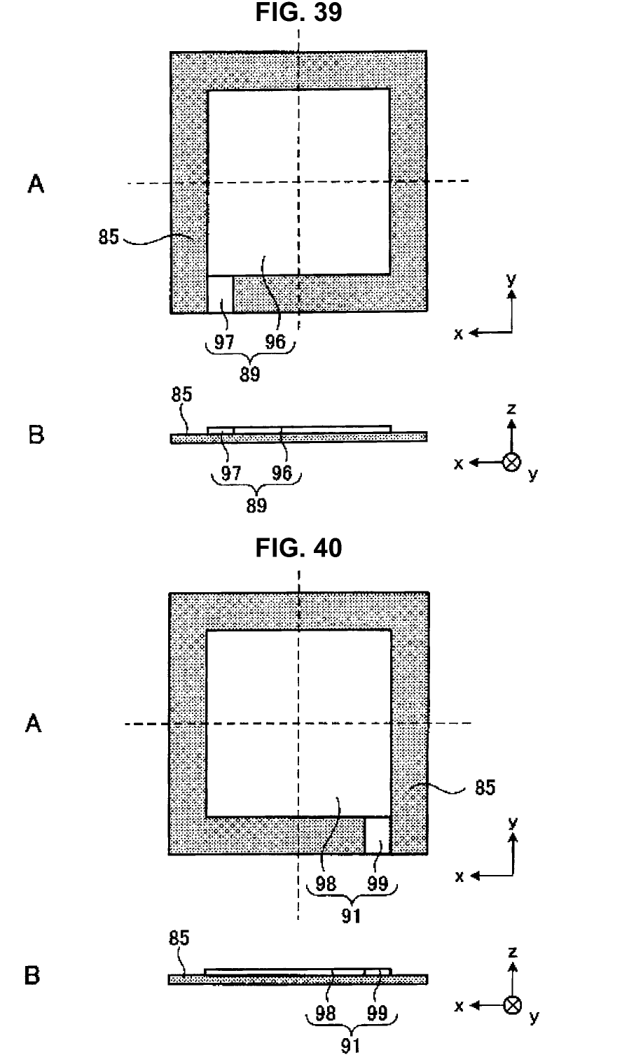

FIG. 37 is an exploded view illustrating the variable capacitance element body 82 when viewed from one side in a long-side direction. Further, FIG. 38A is a plane configuration view illustrating the first internal electrode 88 when viewed from above, and FIG. 38B is a configuration view illustrating the first internal electrode 88 when viewed from one side. Further, FIG. 39A is a plane configuration view illustrating the second internal electrode 89 when viewed from above, and FIG. 39B is a configuration view illustrating the second internal electrode 89 when viewed from one side. Further, FIG. 40A is a plane configuration view illustrating the fourth internal electrode 91 when viewed from above, and FIG. 40B is a configuration view illustrating the fourth internal electrode 91 when viewed from one side. In FIGS. 37 to 40, lines passing through the dielectric layer 85 and the centers (the centers of gravity) of the internal electrodes are indicated by dotted lines.

As illustrated in FIG. 37, the variable capacitance element body 2 has the structure in which the dielectric layers 85 of the sheet shape in which the internal electrode is formed on one surface are stacked. Each of the dielectric layers 85 formed in the sheet shape has the plane shape of the square shape, and in the variable capacitance element body 82, the dielectric layers 85 are stacked in a state in which the side at which the internal electrode is formed faces the upper surface.

Further, in the present embodiment, a plurality of dielectric layers 85 including no electrode are formed below the first internal electrode 88 and above the sixth internal electrode 93, and the dielectric layers 85 configure the lower dielectric layers 86 and the upper dielectric layers 87. The lower dielectric layer 86 and the upper dielectric layer 87 configured with the plurality of dielectric layers 85 can prevent the electrodes from being exposed on the upper surface and the lower surface of the variable capacitance element body 82.

In the present embodiment, since the variable capacitance element 1 is configured to have the capacitance varying according to an applied voltage, the dielectric layer 85 is made of a ferroelectric material. The same ferroelectric material as in the first embodiment may be used in the present embodiment.

The first internal electrode 88 includes an electrode body 94 and a connection electrode 95 as illustrated in FIGS. 38A and 38B. The electrode body 94 has the plane shape of the square shape, and is formed to have an area size smaller than the area size of the dielectric layer 85 formed in the sheet shape, that is, the area size of the xy plane of the variable capacitance element body 82 and not to be exposed on the side surface of the variable capacitance element body 82. Further, the electrode body 94 is formed such that the center of gravity thereof is aligned with the center of the dielectric layer 85.

The connection electrode 95 is formed to be connected to one side of the electrode body 94 extending in the y direction and to be exposed on the side surface of the variable capacitance element body 82. The width of the connection electrode 95 in the x direction is set to be the same as the width of the electrode body 94 in the x direction. An end portion of the connection electrode 95 exposed on the side surface of the variable capacitance element body 82 is electrically connected to the first external terminal 83a.

The second internal electrode 89 includes an electrode body 96 and a connection electrode 97 as illustrated in FIGS. 39A and 39B. The electrode body 96 is formed to have the same size and shape as the electrode body 94 configuring the first internal electrode 88 such that the center thereof is aligned with the center of the dielectric layer 85.

The connection electrode 97 is formed to be connected to one side of the electrode body 96 extending in the x direction and to be exposed on the side surface of the variable capacitance element body 82. The width of the connection electrode 97 in the y direction is set to be sufficiently smaller than the width of the electrode body 96 in the y direction, and the connection electrode 97 is connected to one end portion of the side of the electrode body 96 in the y direction. An end portion of the connection electrode 97 exposed on the side surface of the variable capacitance element body 82 is electrically connected to the second external terminal 83b.

The fourth internal electrode 91 includes an electrode body 98 and a connection electrode 99 as illustrated in FIGS. 40A and 40B. The electrode body 98 is formed to have the same size and shape as the electrode body 94 configuring the first internal electrode 88 such that the center of gravity thereof is aligned with the center of the dielectric layer 85.

The connection electrode 99 is formed to be connected to one side of the electrode body 98 extending in the y direction and to be exposed on the side surface of the variable capacitance element body 82. Further, the width of the connection electrode 99 in the y direction is set to be sufficiently smaller than the width of the electrode body 98 in the y direction, and when viewed on the xy plane, the connection electrode 99 is connected to the other end portion of the side of the electrode body 98 in the y direction to be arranged apart from the connection electrode 97 of the second internal electrode 89. An end portion of the connection electrode 99 exposed on the side surface of the variable capacitance element body 82 is electrically connected to the fourth external terminal 83d.

The third internal electrode 90 has a configuration obtained by rotating the second internal electrode 89 illustrated in FIG. 39A 180 degrees on an axis perpendicular to the electrode plane, and includes an electrode body 96 and a connection electrode 97 which are the same as those of the second internal electrode 89. Thus, when viewed on the xy plane, the connection electrode 97 of the third internal electrode 90 is formed at the position diagonal to the connection electrode 97 of the second internal electrode 89. Further, the connection electrode 97 of the third internal electrode 90 exposed on the side surface of the variable capacitance element body 82 is electrically connected to the third external terminal 83c.

The fifth internal electrode 92 has a configuration obtained by rotating the fourth internal electrode 91 illustrated in FIG. 40A 180 degrees on an axis perpendicular to the electrode plane, and includes an electrode body 98 and a connection electrode 99 which are the same as those of the fourth internal electrode 91. Thus, when viewed on the xy plane, the connection electrode 99 of the fifth internal electrode 92 is formed at the position diagonal to the connection electrode 99 of the fourth internal electrode 91. Further, the connection electrode 99 of the fifth internal electrode 92 exposed on the side surface of the variable capacitance element body 82 is electrically connected to the fifth external terminal 83e.

The sixth internal electrode 93 has a configuration obtained by rotating the first internal electrode 88 illustrated in FIG. 38A 180 degrees on an axis perpendicular to the electrode plane, and includes an electrode body 94 and a connection electrode 95 which are the same as those of the first internal electrode 88. Thus, when viewed on the xy plane, the connection electrode 95 of the sixth internal electrode 93 is formed at the position diagonal to the connection electrode 95 of the first internal electrode 88. Further, the connection electrode 95 of the sixth internal electrode 93 exposed on the side surface of the variable capacitance element body 82 is electrically connected to the sixth external terminal 83f.

The first internal electrode 88 to the sixth internal electrode 93 of the present embodiment may be formed using the same material as in the first embodiment.

The variable capacitance element 81 according to the present embodiment may be formed by the same manufacturing process as in the first embodiment. In other words, the variable capacitance element 81 according to the present embodiment is manufactured by forming the variable capacitance element body 82 through a process of stacking the dielectric sheets on which the respective internal electrodes are formed in the state in which the side on which the electrode is formed faces the upper surface and performing baking, and forming an external terminal at a desired position of the side surface. Further, in the variable capacitance element 81 according to the present embodiment, the first internal electrode 88 and the sixth internal electrode 93, the second internal electrode 89 and the third internal electrode 90, and the fourth internal electrode 91 and the fifth internal electrode 92 have the same shape and thus can be formed using the same mask.

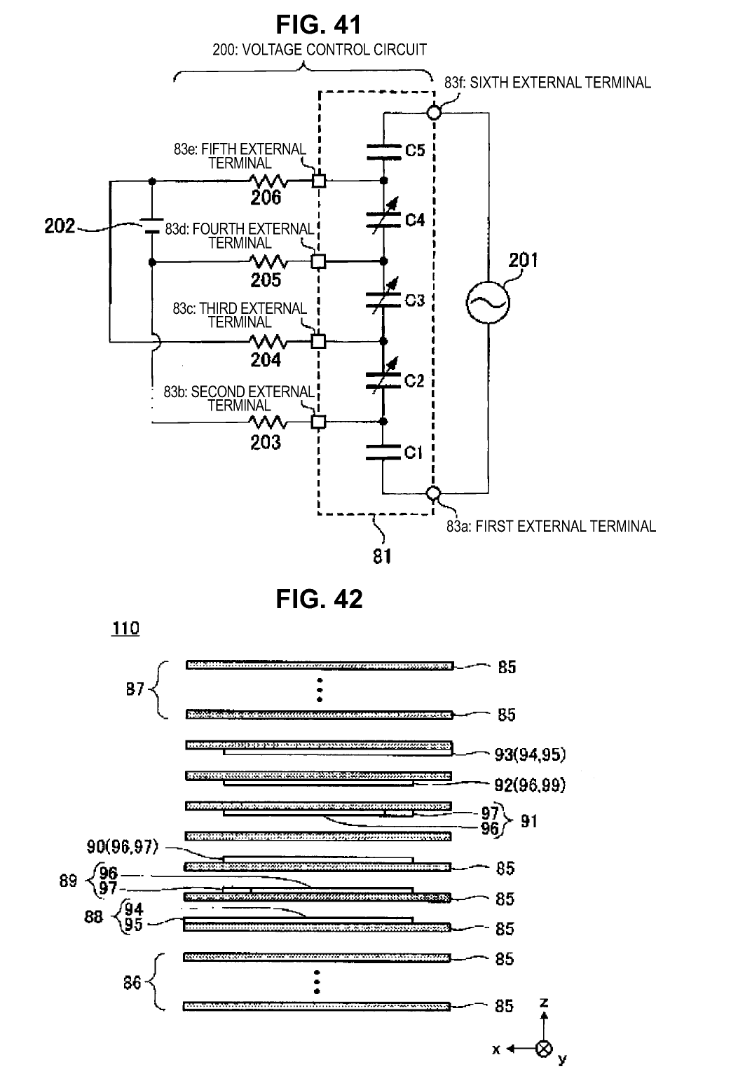

Next, an exemplary voltage control circuit using the variable capacitance element 81 according to the present embodiment will be described. FIG. 41 illustrates a circuit configuration of the voltage control circuit. For example, a voltage control circuit 200 illustrated in FIG. 41 is arranged between an alternating current (AC) source 201 and a circuit such as a rectifying circuit, and adjusts an AC voltage (input signal) input from the AC source 201 to the circuit such as the rectifying circuit to a certain voltage value. The first external terminal 83a to the sixth external terminal 83f of FIG. 41 correspond to the first external terminal 83a to the sixth external terminal 83f of FIG. 36.

In the present embodiment, the first internal electrode 88 to the sixth internal electrode 93 that are stacked are connected to different external terminals (the first external terminal 83a to the sixth external terminal 830. Thus, a first capacitor C1 is formed between the first internal electrode 88 and the second internal electrode 89. Further, a second capacitor C2 is formed between the second internal electrode 89 and the third internal electrode 90. Further, a third capacitor C3 is formed between the third internal electrode 90 and the fourth internal electrode 91. Further, a fourth capacitor C4 is formed between the fourth internal electrode 91 and the fifth internal electrode 92. Further, a fifth capacitor C5 is formed between the fifth internal electrode 92 and the sixth internal electrode 93. Further, the variable capacitance element 81 according to the present embodiment is a circuit in which the first capacitor C1 to the fifth capacitor C5 are connected in series in order.

In the present embodiment, the second capacitor C2, the third capacitor C3, and the fourth capacitor C4 are used as a variable-capacitance capacitor, and the first capacitor C1 and the fifth capacitor C5 are used as a DC removal capacitor. Therefore, the first external terminal 83a of the variable capacitance element 81 are connected to one output terminal of the AC source 201, and the sixth external terminal 83f is connected to the other output terminal of the AC source 201. In other words, the series circuit including the first capacitor C1 to the fifth capacitor C5 is connected to the AC source 201 in parallel. Although not shown in FIG. 41, the circuit such as the rectifying circuit to which a signal applied from the AC source 201 is input is connected in parallel between the first external terminal 83a and the sixth external terminal 83f of the variable capacitance element 81.

Further, the second external terminal 83b and the fourth external terminal 83d are connected to a negative electrode terminal of a control power source 202 through DC removal resistors 203 and 205. Further, the third external terminal 83c and the fifth external terminal 83e are connected to a positive electrode terminal of the control power source 202 through DC removal resistors 204 and 206. In other words, in the variable capacitance element 81 according to the present embodiment, the control power source 202 is connected to the second capacitor C2, the third capacitor C3, and the fourth capacitor C4 in parallel. Further, the capacitance of each of the second capacitor C2, the third capacitor C3, and the fourth capacitor C4 is adjusted by a direct current (DC) signal (a control signal) input from the control power source 202.

The first capacitor C1 and the fifth capacitor C5 used as the DC removal capacitor and the three DC removal resistors are arranged to suppress influence of interference between a DC bias current flowing from the control power source 202 and an AC current flowing from the AC source 201. In the present embodiment, a DC removal inductance (coil) may be used instead of the DC removal resistor.

In the present embodiment, the internal electrode configuring each capacitor and the dielectric layer for the internal electrode have shapes that are high in symmetry. Thus, an improvement in electrical characteristics such as an improvement in a capacitance variable rate of the variable capacitance element 81 and an improvement in the electrostatic capacitance are obtained.

### Modified Example 7-1

Next, the variable capacitance element according to the modified example 7-1 will be described. The variable capacitance element according to the modified example 7-1 has an external appearance configuration, a cross-sectional configuration, and a circuit configuration that are the same as those of the seventh embodiment illustrated in FIGS. 36A, 36B, and 41, and thus an illustration thereof and repeated explanation are omitted.

FIG. 42 is an exploded view illustrating a variable capacitance element body 110 of the variable capacitance element according to the modified example 7-1 when viewed from one side in the long-side direction. In the modified example 7-1, the fourth internal electrode 91 and the fifth internal electrode 92 are formed using a mask used to manufacture the second internal electrode 89 and the third internal electrode 90. In FIG. 42, parts corresponding to those of FIG. 37 are denoted by the same reference numerals, and repeated explanation is omitted.

In the modified example 7-1, the fourth internal electrode 91 has a configuration obtained by rotating the second internal electrode 89 illustrated in FIG. 39A 180 degrees on an axis in the x direction that passes through the center of gravity of the electrode body 96 and is horizontal to the plane of the electrode body 96. In other words, the fourth internal electrode 91 has the configuration obtained by reversing the second internal electrode 89 illustrated in FIG. 39A on the axis in the x direction. Thus, when viewed on the xy plane, the connection electrode 97 of the fourth internal electrode 91 is arranged apart from the connection electrode 97 of the second internal electrode 89. Further, similarly to the seventh embodiment, the fourth external terminal 83d is connected to the connection electrode 97 of the fourth internal electrode 91.

The fifth internal electrode 92 has a configuration obtained by rotating the second internal electrode 89 illustrated in FIG. 39A 180 degrees on an axis in the y direction passing through the center of gravity of the electrode body 96 and rotating it 180 degrees on an axis in the x direction passing through the center of gravity of the electrode body 96. In other words, the fifth internal electrode 92 of the modified example 7-1 has the configuration obtained by reversing the third internal electrode 90 of the seventh embodiment on the axis in the y direction. Further, similarly to the seventh embodiment, the fifth external terminal 83e is connected to the connection electrode 97 of the fifth internal electrode 92.

In the modified example 7-1, the variable capacitance element 81 similar to that of FIG. 36 can be formed by forming the second internal electrode 89 to the fourth internal electrode 91 using the same mask, and stacking the dielectric layers of the sheet shape on which the respective internal electrodes are formed while rotating and/or reversing the dielectric layers. Specifically, as illustrated in FIG. 42, the first internal electrode 88 to the third internal electrode 90 are stacked in the state in which the electrode plane faces the upper surface, and the fourth internal electrode 91 to the sixth internal electrode 93 are stacked in the state in which the electrode plane faces the lower surface. Further, the dielectric layer 85 on which no electrode is formed is interposed between the dielectric layer 85 on which the third internal electrode 90 is formed and the dielectric layer 85 on which the fourth internal electrode 91 is formed, and thus the dielectric layer 85 is formed between the third internal electrode 90 and the fourth internal electrode 91.

As the second internal electrode 89 to the fourth internal electrode 91 formed using the same mask are rotated and/or reversed and then stacked as described above, the respective connection electrodes 97 can be configured to be exposed at different positions of the side surface of the variable capacitance element body. Further, as external terminals are connected to the connection electrodes 97, it is possible to supply different electric potentials to the respective internal electrodes, and similarly to the seventh embodiment, it is possible to configure the capacitor in which the internal electrodes are connected in series in the stacked direction.

As described above, in the modified example 7-1, since the second internal electrode 89 to the fifth internal electrode 92 can be formed using the same mask, the cost can be reduced. In addition, the same effects as in the seventh embodiment can be obtained.

### Modified Example 7-2

Next, a variable capacitance element according to the modified example 7-2 will be described. The variable capacitance element according to the modified example 7-2 has an external appearance configuration, a cross-sectional configuration, and a circuit configuration that are the same as those of the seventh embodiment illustrated in FIGS. 36A, 36B, and 41, and thus an illustration thereof and repeated explanation are omitted.

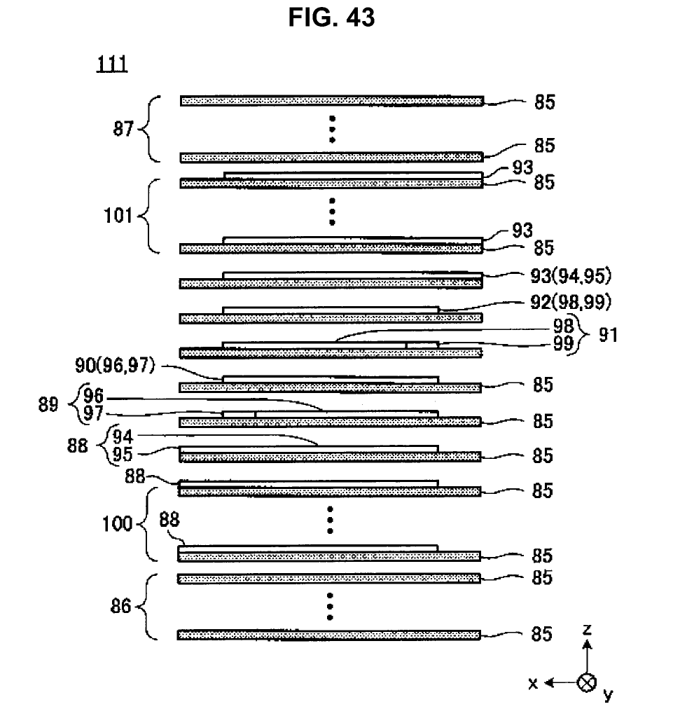

FIG. 43 is an exploded view illustrating a variable capacitance element body 111 of the variable capacitance element according to the modified example 7-1 when viewed from one side in the long-side direction. In the modified example 7-2, stress control units 100 and 101 are formed as a layer below the first internal electrode 88 and as a layer on the sixth internal electrode 93. In FIG. 43, parts corresponding to those of FIG. 37 are denoted by the same reference numerals, and repeated explanation is omitted.

As illustrated in FIG. 43, in the modified example 7-2, the first stress control unit 100 is formed as a layer below the first internal electrode 88, and the second stress control unit 101 is formed as a layer on the sixth internal electrode 93.

The first stress control unit 100 is configured with a plurality of first internal electrodes 88 that are stacked with the dielectric layer 85 interposed therebetween, and the first internal electrode 88 configuring the first stress control unit 100 is connected to the first external terminal 83a, similarly to the first internal electrode 88 configuring the first capacitor C1. Thus, since the first internal electrode 88 configuring the first capacitor C1 and the first internal electrode 88 configuring the first stress control unit 100 have the same electric potential, no capacitor is formed between these electrodes. Further, since the plurality of first internal electrodes 88 formed in the first stress control unit 100 have the same electric potential, no capacitor is formed in the first stress control unit 100.

The second stress control unit 101 is configured with a plurality of sixth internal electrodes 93 that are stacked with the dielectric layer 85 interposed therebetween, and the sixth internal electrode 93 configuring the second stress control unit 101 is connected to the sixth external terminal 83f, similarly to the sixth internal electrode 93 configuring the fifth capacitor C5. Thus, since the sixth internal electrode 93 configuring the fifth capacitor C5 and the sixth internal electrode 93 configuring the second stress control unit 101 have the same electric potential, no capacitor is formed between these electrodes. Further, since the plurality of sixth internal electrodes 93 formed in the second stress control unit 101 have the same electric potential, no capacitor is formed in the second stress control unit 101.

In the variable capacitance element according to the modified example 7-2, residual stress occurs in the first stress control unit 100 and the second stress control unit 101 as well due to the difference in the shrinkage rate between the electrode material and the dielectric material at the time of baking. Thus, since the residual stress is increased by the first stress control unit 100 and the second stress control unit 101, it is possible to increase the capacitance value and the capacitance variable rate compared to when the stress control unit is not formed. In addition, the same effects as in the seventh embodiment can be obtained.

### 8. Eighth Embodiment

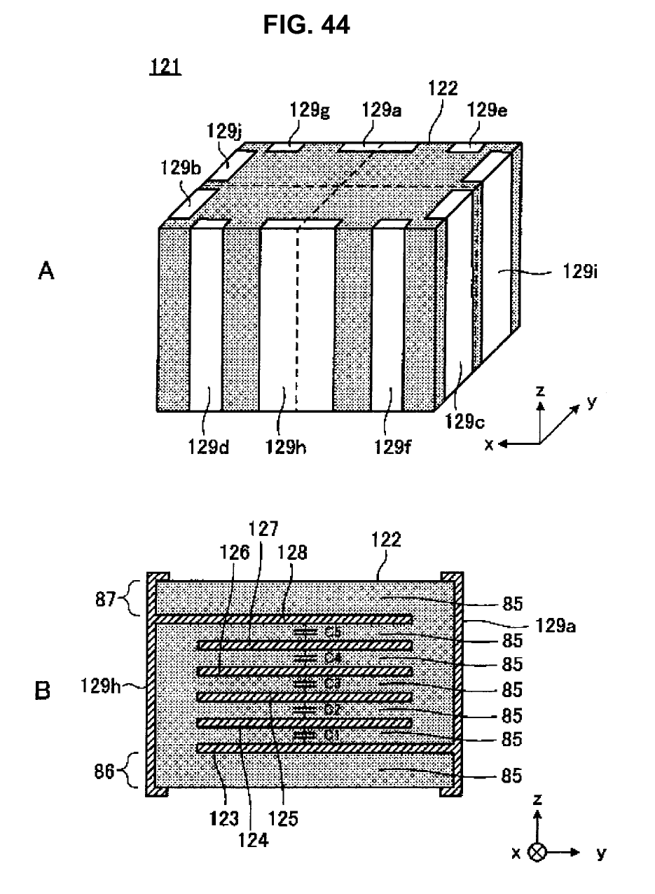

FIG. 44A is a schematic perspective view illustrating a variable capacitance element 121 according to an eighth embodiment of the present disclosure, and FIG. 44B is a cross-sectional configuration view of the variable capacitance element 121. In FIGS. 44A and 44B, parts corresponding to those of FIGS. 36A and 36B are denoted by the same reference numerals, and repeated explanation is omitted.

As illustrated in FIG. 44A, the variable capacitance element 121 according to the present embodiment includes a variable capacitance element body 122 configured with a rectangular parallelepiped member having an xy plane of a square shape and ten external terminals (hereinafter referred to as “a first external terminal 129a to a tenth external terminal 129j”).

The first external terminal 129a to the tenth external terminal 129j are arranged apart from one another on the four side surfaces of the variable capacitance element body 122. Further, the first external terminal 129a and the eighth external terminal 129h, the second external terminal 129b and the third external terminal 129c, and the ninth external terminal 129i and the tenth external terminal 129j are arranged at corresponding positions when viewed on the xy plane. Further, the fourth external terminal 129d and the seventh external terminal 129g, and the fifth external terminal 129e and the sixth external terminal f are arranged at corresponding positions when viewed on the xy plane.

Further, the first external terminal 129a to the tenth external terminal 129j are formed to cover the side surfaces of the variable capacitance element body 122 in the z direction and extend beyond the upper surface and the lower surface of the variable capacitance element body 122.

The variable capacitance element body 122 includes a dielectric layer 85 and six internal electrodes 123 to 128 that are stacked with the dielectric layer 85 interposed therebetween as illustrated in FIG. 44B. In the following description, for convenience, three internal electrodes are referred to as a first internal electrode 123 to a sixth internal electrode 128. A variable capacitance element body 122 according to the present embodiment is configured by stacking the first internal electrode 123 to the sixth internal electrode 128 in order from the lower surface to the upper surface.

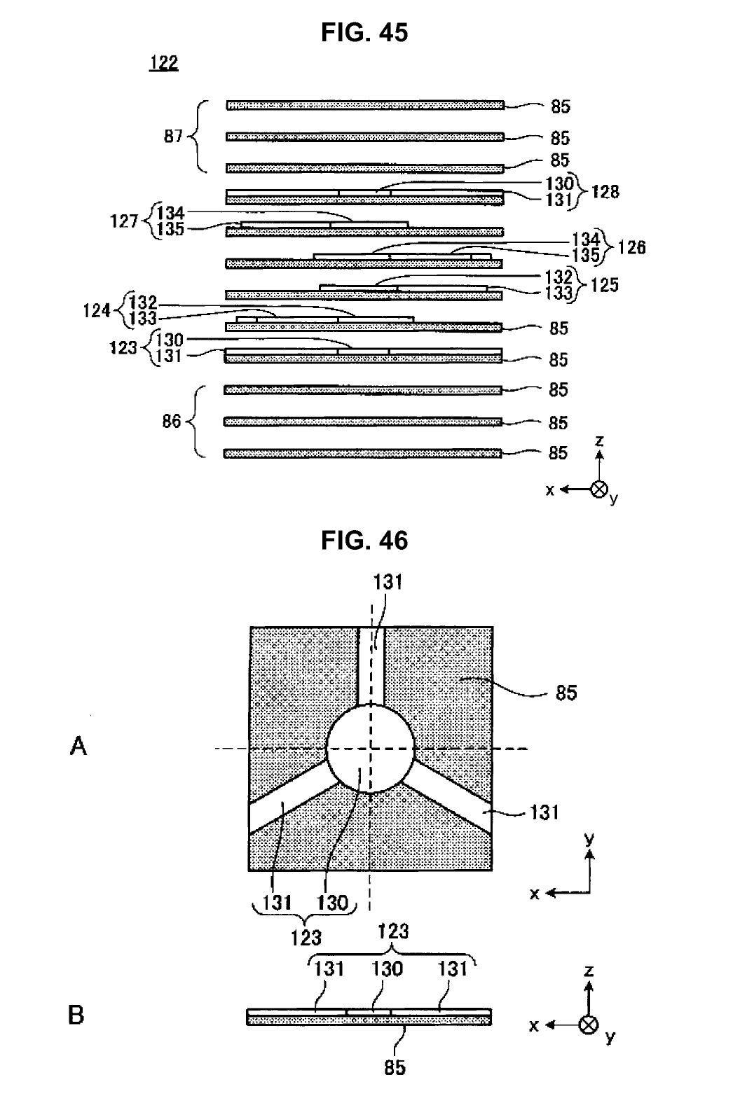

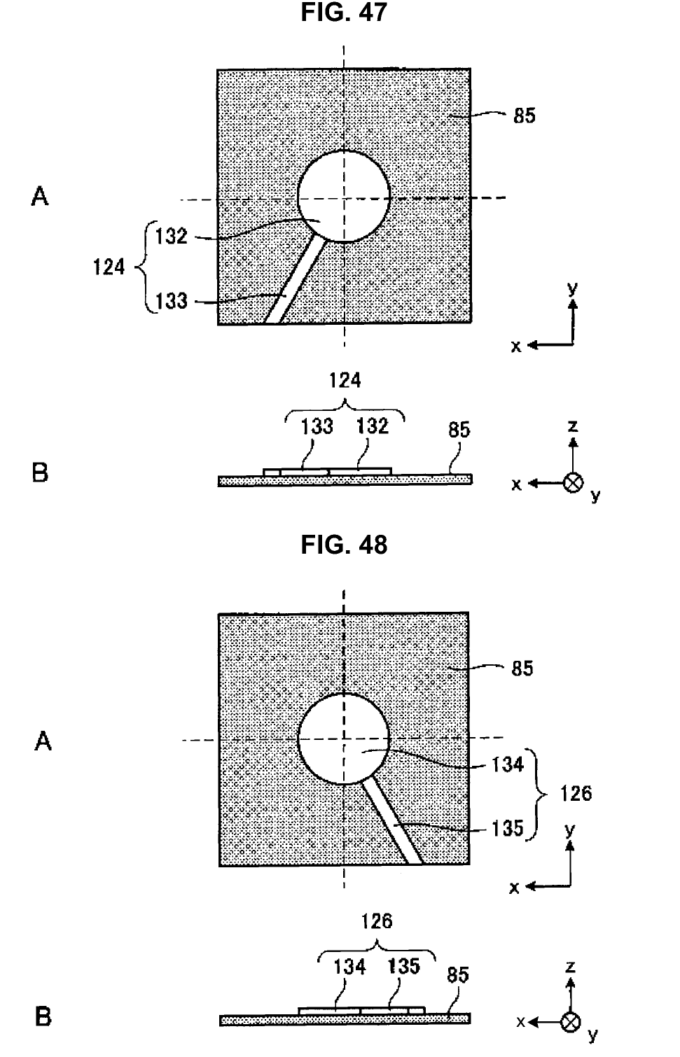

FIG. 45 is an exploded view illustrating the variable capacitance element body 122 when viewed from one side in the long-side direction. FIG. 46A is a plane configuration view illustrating the first internal electrode 123 when viewed from above, and FIG. 46B is a configuration view illustrating the first internal electrode 123 when viewed from one side. FIG. 47A is a plane configuration view illustrating a second internal electrode 124 when viewed from above, and FIG. 47B is a configuration view illustrating the second internal electrode 124 when viewed from one side. FIG. 48A is a plane configuration view illustrating a fourth internal electrode 126 when viewed from above, and FIG. 48B is a configuration view illustrating the fourth internal electrode 126 when viewed from one side. In FIGS. 45 to 48, lines passing through the center (the center of gravity) of the dielectric layer 85 and the respective internal electrodes are indicated by dotted lines.

As illustrated in FIG. 45, the variable capacitance element body 122 has the structure in which the dielectric layers 85 of the sheet shape in which the internal electrode is formed on one side are stacked. The respective dielectric layers 85 formed in the sheet shape have the plane shape of the square shape, and in the variable capacitance element body 122, the dielectric layers 85 are stacked in the state in which the side at which the internal electrode is formed faces the upper surface.

The first internal electrode 123 includes an electrode body 130 and a connection electrode 131 as illustrated in FIGS. 46A and 46B. The electrode body 130 has the plane shape of the circular shape, and is formed to have an area size smaller than the area size of the dielectric layer 85 formed in the sheet shape, that is, the area size of the xy plane of the variable capacitance element body 122, and not to be exposed at the side surface of the variable capacitance element body 122. Further, the electrode body 130 is formed such that the center of gravity thereof is aligned with the center of the dielectric layer 85.

The three connection electrodes 131 are connected to the electrode body 130 at equal intervals in the circumferential direction of the electrode body 130. Further, each of the connection electrodes 131 is formed in the form of a band having a width smaller than the diameter of the electrode body 130 formed in the circular shape. In other words, in the present embodiment, the first internal electrode 123 has the same configuration as the internal electrode 67 of the sixth embodiment illustrated in FIG. 32.

The three connection electrodes 131 configuring the first internal electrode 123 are exposed at the side surfaces of the variable capacitance element body 122, and connected to different external terminals, that is, the first external terminal 129a to the third external terminal 129c.

The second internal electrode 124 includes an electrode body 132 and a connection electrode 133 as illustrated in FIGS. 47A and 48B. The electrode body 132 is formed to have the same size and shape as the electrode body 130 configuring the first internal electrode 123 such that the center of gravity thereof is aligned with the center of the dielectric layer 85.

The connection electrode 133 is connected to the electrode body 132, and arranged on a straight line passing through the center of gravity (the center) of the electrode body 132. Further, the connection electrode 133 is formed to be exposed at the position deviated from the center of the side surface configured with the xz plane of the variable capacitance element body 122. Further, the connection electrode 133 is formed in the form of a band having a width smaller than the diameter of the electrode body 132 formed in the circular shape. In other words, in the present embodiment, the second internal electrode 124 has the same configuration as the internal electrode 20 of the modified example 2-2 illustrated in FIG. 12. Further, the connection electrode 133 configuring the second internal electrode 124 is exposed at one side surface configured with the xz plane of the variable capacitance element body 122, and an end portion thereof is electrically connected to the fourth external terminal 129d.

The fourth internal electrode 126 includes an electrode body 134 and a connection electrode 135 as illustrated in FIGS. 48A and 48B. The electrode body 134 132 is formed to have the same size and shape as the electrode body 130 configuring the first internal electrode 123 such that the center of gravity thereof is aligned with the center of the dielectric layer 85.

The connection electrode 135 is connected to the electrode body 134, and arranged on a straight line passing through the center of gravity (the center) of the electrode body 134. Further, the connection electrode 135 is formed to be exposed at the position deviated from the center of the side surface configured with the xz plane of the variable capacitance element body 122. Further, the connection electrode 135 is formed in the form of a band having a width smaller than the diameter of the electrode body 134 formed in the circular shape. In other words, in the present embodiment, the fourth internal electrode 126 has the same configuration as the second internal electrode 124 and the same configuration as the internal electrode 20 of the modified example 2-2 illustrated in FIG. 12.

Further, in the present embodiment, the connection electrode 135 of the fourth internal electrode 126 is formed to be line-symmetric to the connection electrode 133 of the second internal electrode 124 with respect to an axis in the y direction passing through the center of gravity of the electrode body 134. Further, the connection electrode 135 configuring the fourth internal electrode 126 is exposed at one side surface configured with the xz plane of the variable capacitance element body 122, and an end portion thereof is electrically connected to the sixth external terminal 129f.

The third internal electrode 125 has a configuration obtained by rotating the second internal electrode 124 illustrated in FIG. 46A 180 degrees on the axis in the z direction passing through the center of gravity of the electrode body 132, and includes an electrode body 132 and a connection electrode 133 that are the same as those of the second internal electrode 124. Thus, the connection electrode 133 of the third internal electrode 125 is formed at the position diagonal to the connection electrode 133 of the second internal electrode 124 when viewed on the xy plane. Further, the connection electrode 133 of the third internal electrode 125 exposed at the side surface of the variable capacitance element body 122 is electrically connected to the fifth external terminal 129e.

The fifth internal electrode 127 has a configuration obtained by rotating the fourth internal electrode 126 illustrated in FIG. 47A 180 degrees on the axis in the z direction passing through the center of gravity of the electrode body 134, and includes an electrode body 134 and a connection electrode 135 that are the same as those of the fourth internal electrode 126. Thus, the connection electrode 135 of the fifth internal electrode 127 is formed at the position diagonal to the connection electrode 135 of the fourth internal electrode 126 when viewed on the xy plane. Further, the connection electrode 135 of the fifth internal electrode 127 exposed at the side surface of the variable capacitance element body 122 is electrically connected to the seventh external terminal 129g.

The sixth internal electrode 128 has a configuration obtained by rotating the first internal electrode 123 illustrated in FIG. 46A 180 degrees on the axis in the z direction passing through the center of gravity of the electrode body 130, and includes an electrode body 130 and a connection electrode 131 that are the same as those of the first internal electrode 123. Thus, the three connection electrodes 131 of the sixth internal electrode 128 are formed at the position diagonal to the three connection electrodes 131 of the first internal electrode 123 when viewed on the xy plane. Further, the three connection electrode 131 of the sixth internal electrode 128 exposed at the side surface of the variable capacitance element body 122 are electrically connected to the eighth external terminal 129h to the tenth external terminal 129j.

The first internal electrode 123 to the sixth internal electrode 128 of the present embodiment may be formed using the same material as in the first embodiment.

The variable capacitance element 121 according to the present embodiment can be manufactured through the same manufacturing process as in the first embodiment. In other words, the variable capacitance element according to the present embodiment is manufactured by forming the variable capacitance element body through a process of stacking the dielectric sheets on which the respective internal electrodes are formed in the state on which the side on which the electrode is formed faces the upper surface and performing baking, and forming an external terminal at a desired position of the side surface. Further, in the variable capacitance element 121 according to the present embodiment, the first internal electrode 123 and the sixth internal electrode 128, the second internal electrode 124 and the third internal electrode 125, and the fourth internal electrode 126 and the fifth internal electrode 127 have the same shape and thus can be formed using the same mask.

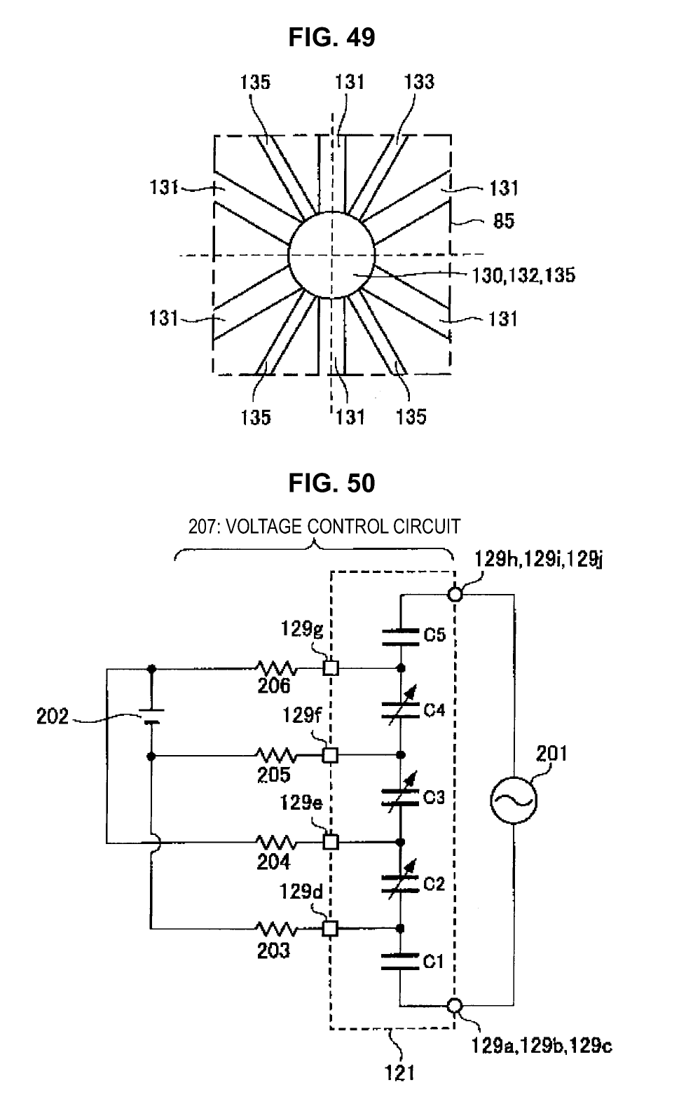

FIG. 49 is a configuration view illustrating the first internal electrode 123 to the sixth internal electrode 128 of the variable capacitance element 121 according to the present embodiment when the inside is viewed from above. As illustrated in FIG. 49, in the present embodiment, all connection electrodes in the first internal electrode 123 to the sixth internal electrode 128 are arranged not to overlap in the stacked direction. Thus, no capacitance is formed between the stacked connection electrodes.

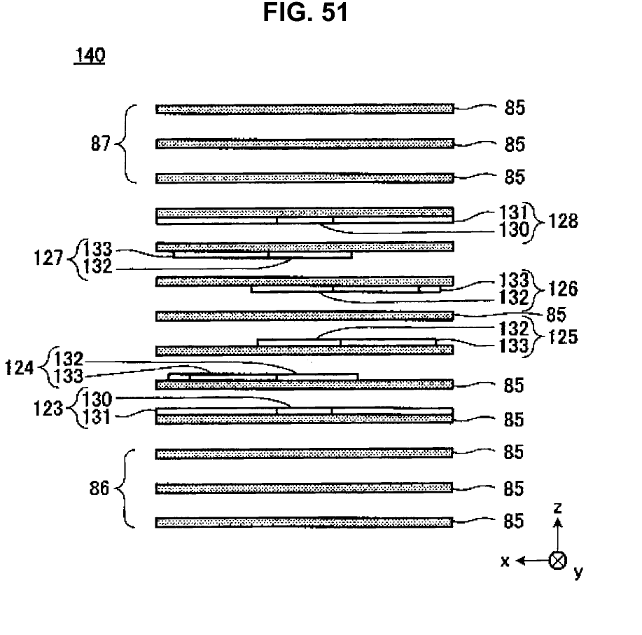

Next, an exemplary voltage control circuit using the variable capacitance element 121 according to the present embodiment will be described. FIG. 50 illustrates a circuit configuration of a voltage control circuit 207. In FIG. 50, parts corresponding to those of FIG. 41 are denoted by the same reference numerals, and repeated explanation is omitted.

In the present embodiment, the first internal electrode 123 to the sixth internal electrode 128 that are stacked are connected to different external terminals (the first external terminal 129a to the tenth external terminal 129j). Thus, a first capacitor C1 is formed between the first internal electrode 123 and the second internal electrode 124. Further, a second capacitor C2 is formed between the second internal electrode 124 and the third internal electrode 125. Further, a third capacitor C3 is formed between the third internal electrode 125 and the fourth internal electrode 126. Further, a fourth capacitor C4 is formed between the fourth internal electrode 126 and the fifth internal electrode 127. Further, a fifth capacitor C5 is formed between the fifth internal electrode 127 and the sixth internal electrode 128. Further, the variable capacitance element 121 according to the present embodiment is a circuit in which the first capacitor C1 to the fifth capacitor C5 are connected in series in order.

In the present embodiment, the second capacitor C2, the third capacitor C3, and the fourth capacitor C4 are used as a variable-capacitance capacitor, and the first capacitor C1 and the fifth capacitor C5 are used as a DC removal capacitor. Therefore, the first external terminal 129a to the third external terminal 129c connected to the first internal electrode 123 is connected to one output terminal of the AC source 201. Meanwhile, the eighth external terminal 129h to the tenth external terminal 129j connected to the sixth internal electrode 128 is connected to the other output terminal of the AC source 201.

Further, the fourth external terminal 129d and the sixth external terminal 129f are connected to a negative electrode terminal of a control power source 202 through DC removal resistors 203 and 205. Further, the fifth external terminal 129e and the seventh external terminal 129g are connected to a positive electrode terminal of the control power source 202 through DC removal resistors 204 and 206. In other words, in the variable capacitance element 121 according to the present embodiment, the control power source 202 is connected to the second capacitor C2, the third capacitor C3, and the fourth capacitor C4 in parallel. Further, the capacitance of each of the second capacitor C2, the third capacitor C3, and the fourth capacitor C4 is adjusted by a DC signal (a control signal) input from the control power source 202.

In the present embodiment, signals of an AC power source from the three connection electrodes are input to the first internal electrode 123 and the sixth internal electrode 128. Thus, a withstand voltage to a signal input from an AC power source is improved.

In addition, the same effects as in the seventh embodiment can be obtained. Further, the variable capacitance element according to the present embodiment may be provided with a stress control unit, similarly to the modified example 7-2 of the seventh embodiment.

### Modified Example 8-1

Next, a variable capacitance element according to the modified example 8-1 will be described. The variable capacitance element according to the modified example 8-1 has an external appearance configuration, a cross-sectional configuration, and a circuit configuration that are the same as those of the eighth embodiment illustrated in FIGS. 44A, 44B, and 50, and thus illustration and repeated explanation thereof are omitted.

FIG. 51 is an exploded view illustrating a variable capacitance element body 140 of the variable capacitance element according to the modified example 8-1 when viewed from one side in the long-side direction. In the modified example 8-1, the fourth internal electrode 126 and the fifth internal electrode 127 are formed using a mask used to manufacture the second internal electrode 124 and the third internal electrode 125. In FIG. 51, parts corresponding to those of FIG. 45 are denoted by the same reference numerals, and repeated explanation is omitted.

In the modified example 8-1, the fourth internal electrode 126 has a configuration obtained by rotating the second internal electrode 124 illustrated in FIG. 47A 180 degrees on an axis in the y direction that passes through the center of gravity of the electrode body 132. In other words, the fourth internal electrode 126 has the configuration obtained by reversing the second internal electrode 124 illustrated in FIG. 47A on the axis in the y direction. Thus, when viewed on the xy plane, the connection electrode 133 of the fourth internal electrode 126 is arranged apart from the connection electrode 133 of the second internal electrode 124. Further, similarly to the eighth embodiment, the sixth external terminal 129f is connected to the connection electrode 133 of the fourth internal electrode 126.

The fifth internal electrode 127 has a configuration obtained by rotating the second internal electrode 124 illustrated in FIG. 47A 180 degrees on an axis in the y direction passing through the center of gravity of the electrode body 132 and rotating it 180 degrees on an axis in the z direction passing through the center of gravity of the electrode body 132. In other words, the fifth internal electrode 127 has the configuration obtained by reversing the third internal electrode 125 of the eighth embodiment on the axis in the y direction. Further, similarly to the eighth embodiment, the seventh external terminal 129g is connected to the connection electrode 133 of the fifth internal electrode 127.

In the modified example 8-1, the variable capacitance element 121 similar to that of FIG. 44B can be formed by forming the second internal electrode 124 to the fifth internal electrode 127 using the same mask, and stacking the dielectric layers of the sheet shape on which the respective internal electrodes are formed while rotating and/or reversing the dielectric layers. Specifically, as illustrated in FIG. 51, the first internal electrode 123 to the third internal electrode 125 are stacked in the state in which the electrode plane faces the upper surface, and the fourth internal electrode 126 to the sixth internal electrode 128 are stacked in the state in which the electrode plane faces the lower surface. Further, the dielectric layer 85 on which no electrode is formed is interposed between the dielectric layer 85 on which the third internal electrode 125 is formed and the dielectric layer 85 on which the fourth internal electrode 126 is formed, and thus the dielectric layer 85 is formed between the third internal electrode 125 and the fourth internal electrode 126.

As described above, in the modified example 8-1, since the second internal electrode 124 to the fifth internal electrode 127 can be formed using the same mask, the cost can be reduced. In addition, the same effects as in the seventh embodiment can be obtained.

Further, the variable capacitance element according to the modified example 8-1 may be provided with a stress control unit, similarly to the variable capacitance element according to the modified example 7-2 of the seventh embodiment.

### 9. Ninth Embodiment

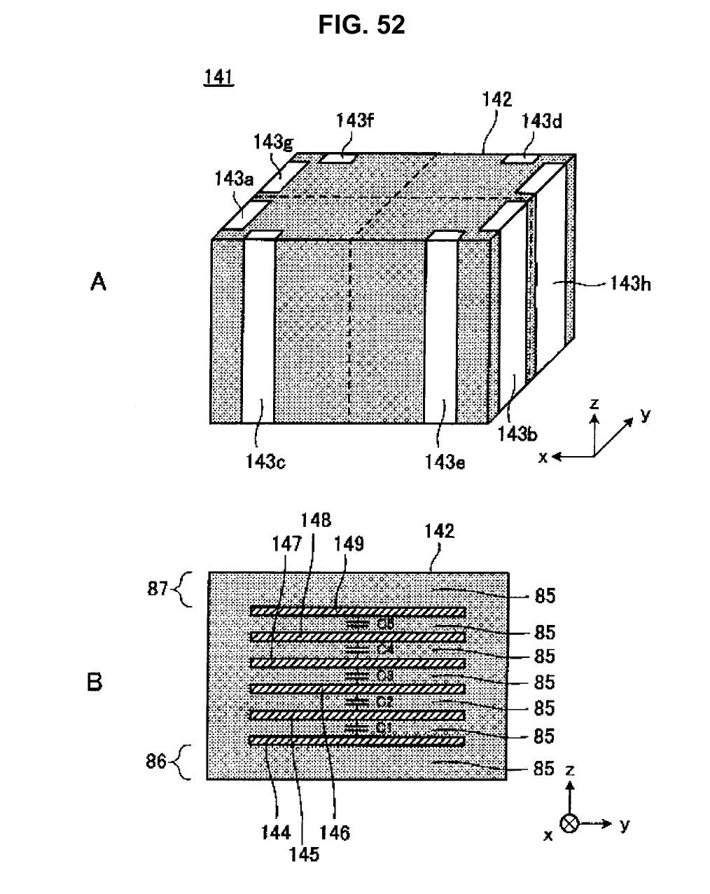

FIG. 52A is a schematic perspective view illustrating a variable capacitance element 141 according to a ninth embodiment of the present disclosure, and FIG. 52B is a cross-sectional configuration view of the variable capacitance element 141. The variable capacitance element 141 according to the present embodiment differs from the variable capacitance element 121 according to the seventh embodiment in configurations of a first internal electrode 144 and a sixth internal electrode 149. In FIGS. 52A and 52B, parts corresponding to those of FIGS. 36A and 36B are denoted by the same reference numerals, and repeated explanation is omitted.

As illustrated in FIG. 52A, the variable capacitance element 141 according to the present embodiment includes a variable capacitance element body 142 configured with a rectangular parallelepiped member having an xy plane of a square shape and eight external terminals (hereinafter referred to as “first to eighth external terminals 143a to 143h”).

The first external terminal 143a to the eighth external terminal 143h are arranged apart from one another on the four side surfaces of the variable capacitance element body 142. Further, the first external terminal 143a and the second external terminal 143b, the third external terminal 143c and the sixth external terminal 143f, the fourth external terminal 143d and the fifth external terminal 143e, and the seventh external terminal 143g and the eighth external terminal 143h are arranged at opposite positions when viewed on the xy plane.

Further, the first external terminal 143a to the eighth external terminal 143h are formed to cover the side surfaces of the variable capacitance element body 142 in the z direction and to extend beyond the upper surface and the lower surface of the variable capacitance element body 142.

The variable capacitance element body 142 includes a dielectric layer 85 and six internal electrodes stacked with the dielectric layer 85 interposed therebetween as illustrated in FIG. 52B. In the following description, for convenience, the six internal electrodes are referred to as “first to sixth internal electrodes 144 to 149.” The variable capacitance element body 142 according to the present embodiment is configured by stacking the first internal electrode 144 to the sixth internal electrode 149 in order from a lower surface to an upper surface.

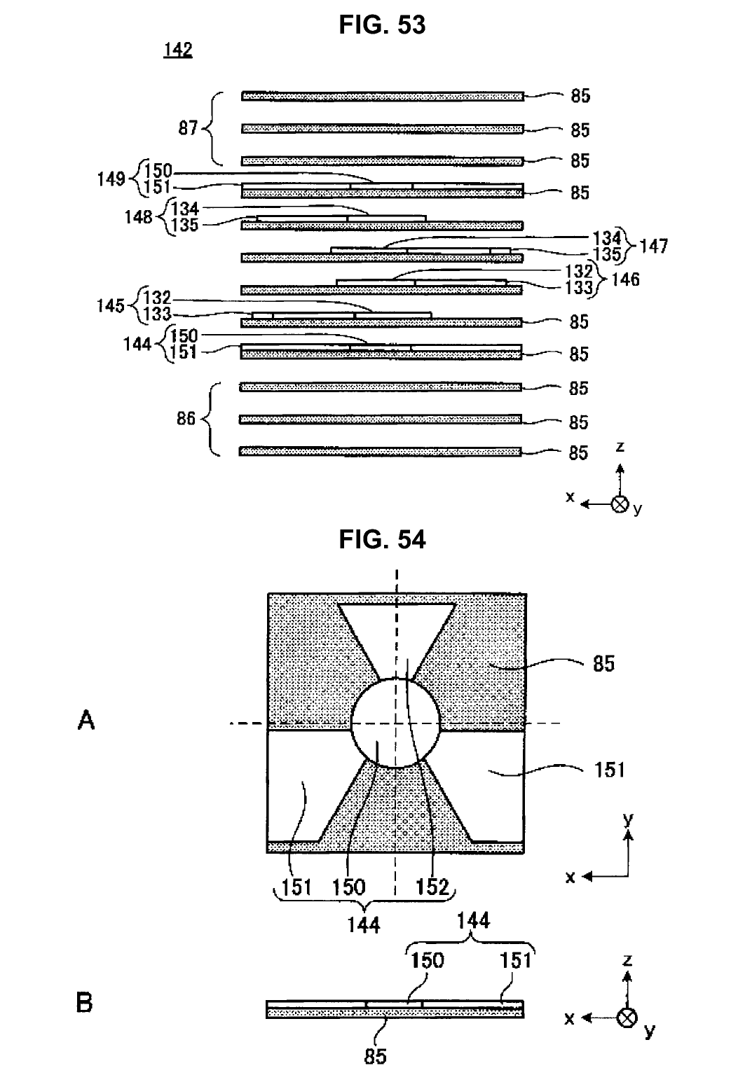

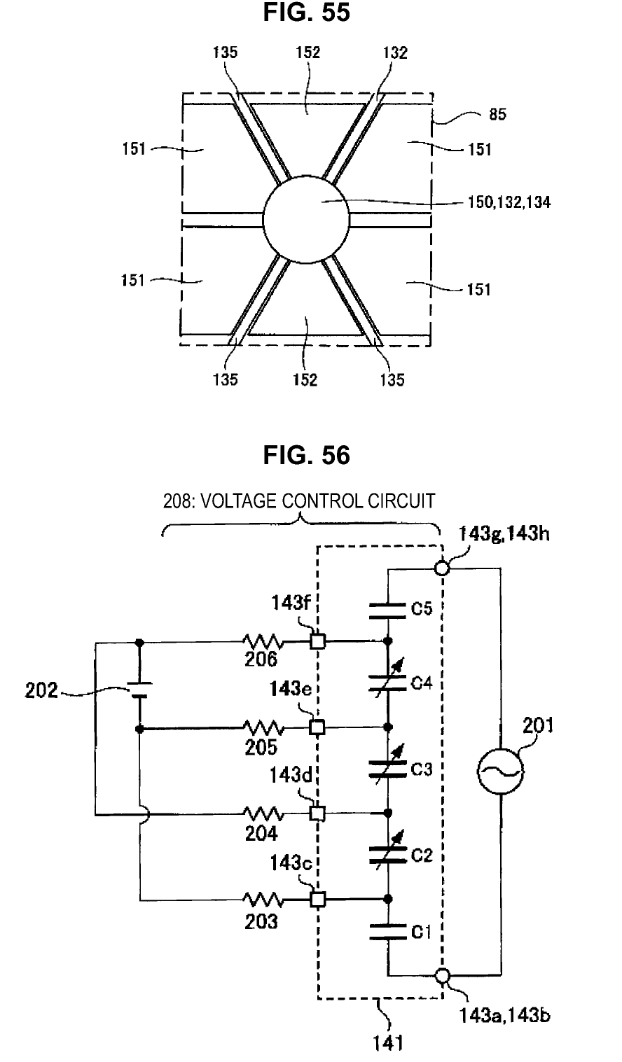

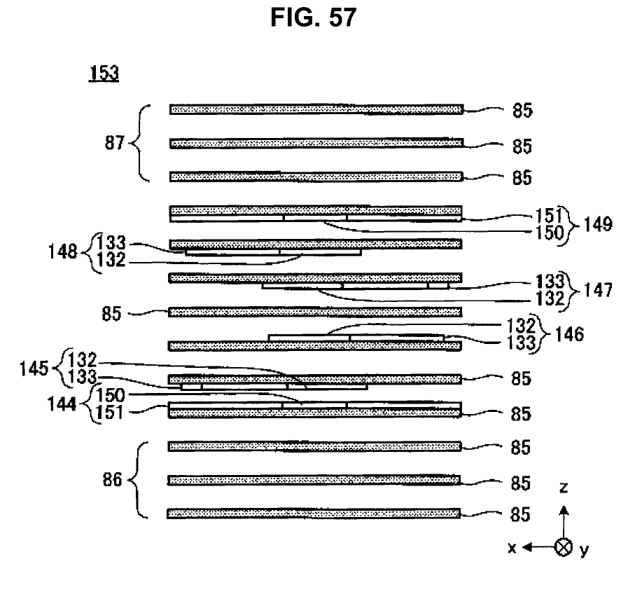

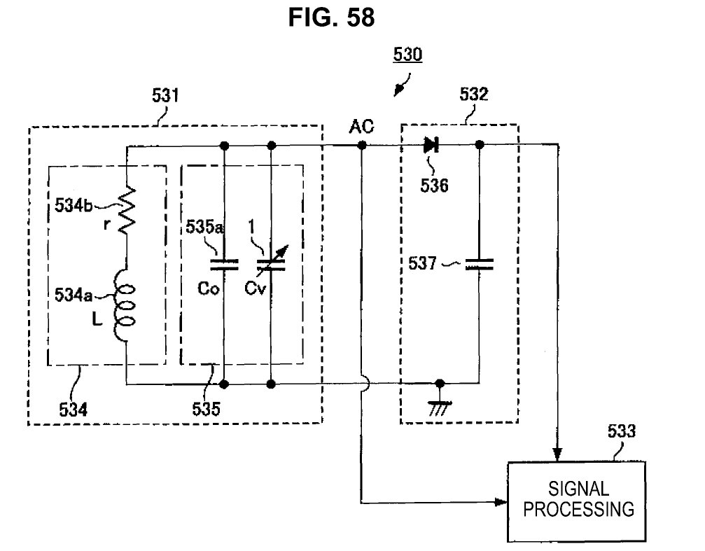

FIG. 53 is an exploded view illustrating the variable capacitance element body 142 when viewed from one side in a long-side direction. Further, FIG. 54A is a plane configuration view illustrating the first internal electrode 144 when viewed from above, and FIG. 54B is a configuration view illustrating the first internal electrode 144 when viewed from one side.

As illustrated in FIGS. 54A and 54B, the first internal electrode 144 includes an electrode body 150, two connection electrodes 151, and a dummy electrode 152. The electrode body 150 has the plane shape of the circular shape, and is formed to have the area size smaller than the area size of the dielectric layer 85 formed in the sheet shape, that is, the area size of the xy plane of the variable capacitance element body 142 and not to be exposed on the side surface of the variable capacitance element body 142. Further, the electrode body 150 is formed such that the center of gravity thereof is aligned with the center of the dielectric layer 85.

The connection electrode 151 and the dummy electrode 152 are formed at almost equal intervals in the circumferential direction of the electrode body 150. Further, the two connection electrodes 151 are formed to be exposed at the opposite side surfaces of the variable capacitance element body 142. Further, the dummy electrode 152 is formed toward the side surface of the variable capacitance element body 142 but not to be exposed at the side surface. Further, the connection electrode 151 and the dummy electrode 152 are formed to have widths that increase from the electrode body 150 side to the side surface of the variable capacitance element body 142. Further, one of the two connection electrodes 151 configuring the first internal electrode 144 is connected to the first external terminal 143a, and the other is connected to the second external terminal 143b.

The sixth internal electrode 149 has a configuration obtained by rotating the first internal electrode 144 illustrated in FIG. 54A 180 degrees on an axis in the z direction passing through the center of gravity of the electrode body 150, and includes an electrode body 150, a connection electrode 151, and a dummy electrode 152 which are the same as those of the first internal electrode 144. Further, the two connection electrodes 151 of the sixth internal electrode 149 exposed on the side surface of the variable capacitance element body 142 are electrically connected to the seventh external terminal 143g and the eighth external terminal h.

Further, in the present embodiment, the second internal electrode 145 to the fifth internal electrode 148 have the same configuration as the second internal electrode 124 to the fifth internal electrode 127 in the seventh embodiment. In other words, each of the second internal electrode 145 and the third internal electrode 146 includes an electrode body 132 and a connection electrode 133, similarly to the second internal electrode 124 and the third internal electrode 125 illustrated in FIGS. 47A and 47B. Further, each of the fourth internal electrode 147 and the fifth internal electrode 148 includes the electrode body 134 and the connection electrode 135 illustrated in FIGS. 48A and 48B. Further, the second internal electrode 145 to the fifth internal electrode 148 are connected to the third external terminal 143c to the sixth external terminal 143f, respectively.

The variable capacitance element 141 according to the present embodiment may be manufactured through the same manufacturing process as in the first embodiment. In other words, the variable capacitance element 141 according to the present embodiment is manufactured by forming the variable capacitance element body 142 through a process of stacking the dielectric sheets on which the respective internal electrodes are formed in the state on which the side on which the electrode is formed serves as the upper surface and performing baking, and forming an external terminal at a desired position of the side surface. Further, in the variable capacitance element 141 according to the present embodiment, the first internal electrode 144 and the sixth internal electrode 149, the second internal electrode 145 and the third internal electrode 146, and the fourth internal electrode 147 and the fifth internal electrode 148 have the same shape and thus can be formed using the same mask.

FIG. 55 is a configuration view illustrating the first internal electrode 144 to the sixth internal electrode 149 of the variable capacitance element 141 according to the present embodiment when the inside is viewed from above. As illustrated in FIG. 55, in the present embodiment, all connection electrodes in the first internal electrode 144 to the sixth internal electrode 149 are arranged not to overlap in the stacked direction. Thus, no capacitance is formed between the stacked connection electrodes.

Next, an exemplary voltage control circuit using the variable capacitance element 141 according to the present embodiment will be described. FIG. 56 illustrates a circuit configuration of a voltage control circuit 208. In FIG. 56, parts corresponding to those of FIG. 41 are denoted by the same reference numerals, and repeated explanation is omitted.

In the present embodiment, the first internal electrode 144 to the sixth internal electrode 149 that are stacked are connected to different external terminals (the first external terminal 143a to the eighth external terminal 143h). Thus, a first capacitor C1 is formed between the first internal electrode 144 and the second internal electrode 145. Further, a second capacitor C2 is formed between the second internal electrode 145 and the third internal electrode 146. Further, a third capacitor C3 is formed between the third internal electrode 146 and the fourth internal electrode 147. Further, a fourth capacitor C4 is formed between the fourth internal electrode 147 and the fifth internal electrode 148. Further, a fifth capacitor C5 is formed between the fifth internal electrode 148 and the sixth internal electrode 149. Further, the variable capacitance element 141 according to the present embodiment is a circuit in which the first capacitor C1 to the fifth capacitor C5 are connected in series in order.

In the present embodiment, the second capacitor C2, the third capacitor C3, and the fourth capacitor C4 are used as a variable-capacitance capacitor, and the first capacitor C1 and the fifth capacitor C5 are used as a DC removal capacitor. Therefore, the first external terminal 143a and the second external terminal 143b connected to the first internal electrode 144 is connected to one output terminal of the AC source 201. Meanwhile, the seventh external terminal 143g and the eighth external terminal 143h connected to the sixth internal electrode 149 is connected to the other output terminal of the AC source 201.

Further, the third external terminal 143c and the fifth external terminal 143e are connected to a negative electrode terminal of a control power source 202 through DC removal resistors 203 and 205. Further, the fourth external terminal 143d and the sixth external terminal 143f are connected to a positive electrode terminal of the control power source 202 through DC removal resistors 204 and 206. In other words, in the variable capacitance element 141 according to the present embodiment, the control power source 202 is connected to the second capacitor C2, the third capacitor C3, and the fourth capacitor C4 in parallel. Further, the capacitance of each of the second capacitor C2, the third capacitor C3, and the fourth capacitor C4 is adjusted by a DC signal (a control signal) input from the control power source 202.

In the present embodiment, signals of an AC power source from the two connection electrodes are input to the first internal electrode 144 and the sixth internal electrode 149. Thus, a withstand voltage to a signal input from an AC power source is improved. Further, in the present embodiment, in the first internal electrode 144 and the sixth internal electrode 149, the side of the connection electrode 151 connected to the external terminal has the wide width. Thus, in the variable capacitance element 141, the withstand voltage can be further improved. Further, in the first internal electrode 144 and the sixth internal electrode 149, as the dummy electrode 152 is formed, symmetry of the internal electrode is improved, and thus the residual stress is improved.

The present embodiment has been described in connection with the example in which the dummy electrode 152 is provided, but similarly to the sixth embodiment, the three connection electrodes may be formed to be exposed on the side surface of the variable capacitance element body 142 and connected to the external terminals. In this case, since the number of external electrodes connected to an AC power source increases, the withstand voltage can be further improved.

Further, the variable capacitance element 141 according to the present embodiment may be provided with a stress control unit, similarly to the modified example 7-2.

### Modified Example 9-1

Next, a variable capacitance element according to the modified example 9-1 will be described. The variable capacitance element according to the modified example 9-1 has an external appearance configuration, a cross-sectional configuration, and a circuit configuration that are the same as those of the ninth embodiment illustrated in FIGS. 52A, 52B, and 56, and thus illustration and repeated explanation thereof are omitted.

FIG. 57 is an exploded view illustrating a variable capacitance element body 153 of the variable capacitance element according to the modified example 9-1 when viewed from one side surface in the long-side direction. In the modified example 9-1, the fourth internal electrode 147 and the fifth internal electrode 148 are formed using a mask used to manufacture the second internal electrode 145 and the third internal electrode 146. In FIG. 57, parts corresponding to those of FIG. 53 are denoted by the same reference numerals, and repeated explanation is omitted.

In the modified example 9-1, the fourth internal electrode 147 has a configuration obtained by rotating the second internal electrode 145 180 degrees on an axis in the y direction that passes through the center of gravity of the electrode body 132. In other words, the second internal electrode 145 has the configuration obtained by reversing the second internal electrode 145 on the axis in the y direction. Thus, when viewed on the xy plane, the connection electrode 133 of the fourth internal electrode 147 and the connection electrode 133 of the second internal electrode 145 are arranged apart from each other on the same side surface. Further, similarly to the ninth embodiment, the fifth external terminal 143e is connected to the connection electrode 133 of the fourth internal electrode 147.

The fifth internal electrode 148 has a configuration obtained by rotating the second internal electrode 145 180 degrees on an axis in the y direction passing through the center of gravity of the electrode body 132 and rotating it on 180 degrees on an axis in the z direction passing through the center of gravity of the electrode body 132. In other words, the fifth internal electrode 148 has the configuration obtained by reversing the third internal electrode 146 of the eighth embodiment on the axis in the y direction. Further, similarly to the eighth embodiment, the sixth external terminal 143f is connected to the connection electrode 133 of the fifth internal electrode 148.

In the modified example 9-1, the variable capacitance element body 153 similar to that of FIG. 52B can be formed by forming the second internal electrode 145 to the fifth internal electrode 148 using the same mask, and stacking the dielectric layers 85 of the sheet shape on which the respective internal electrodes are formed while rotating and/or reversing the dielectric layers. Specifically, as illustrated in FIG. 57, the first internal electrode 144 to the third internal electrode 146 are stacked in the state in which the electrode plane faces the upper surface, and the fourth internal electrode 147 to the sixth internal electrode 149 are stacked in the state in which the electrode plane faces the lower surface. Further, the dielectric layer 85 on which no electrode is formed is interposed between the dielectric layer 85 on which the third internal electrode 146 is formed and the dielectric layer 85 on which the fourth internal electrode 147 is formed, and thus the dielectric layer 85 is formed between the third internal electrode 146 and the fourth internal electrode 147.

As described above, in the modified example 9-1, since the second internal electrode 145 to the fifth internal electrode 148 can be formed using the same mask, the cost can be reduced. In addition, the same effects as in the eighth embodiment can be obtained.

Further, the variable capacitance element according to the modified example 9-1 may be provided with a stress control unit, similarly to the modified example 7-2.

Meanwhile, in the first to ninth embodiments, in each internal electrode, the width of the end portion of the connection electrode connected to the external terminal is set to be smaller than the width of the electrode body, but the width of the end portion of the connection electrode connected to the external terminal can be appropriately changed. For example, for an electrode to which only a DC voltage is applied, since high electric resistance in the connection electrode is not problematic, the width of the connection electrode smaller than the width of the electrode body is allowed, but for an electrode to which an AC current flows, it is preferable that the connection electrode be formed to have the large width in view of electric resistance. Further, when the residual stress is controlled by the stress control unit or the multi-layer stacked electrode, the connection electrode of the outermost electrode may have the large width. Further, as a method of reducing electrode resistance of the connection electrode, there are a method of increasing the width of the electrode, a method of reducing the length, and a method of increasing the thickness, but it is possible to employ a preferable form by combining these methods.

Further, the first to ninth embodiments have been described in connection with the variable capacitance element in which capacitance varies according to an applied voltage as an example of a capacitance element, but the present disclosure is not limited to this example. The configurations described in the first to ninth embodiments can be applied to a capacitance element (hereinafter referred to as a “constant-capacitance element”) in which capacitance hardly varies regardless of a type of an input signal and a signal level thereof as well.

In this case, a dielectric layer is made of a paraelectric material that is low in a relative dielectric constant. Examples of the paraelectric material include paper, polyethylene terephthalate, polypropylene, polyphenylene sulfide, polystyrene, TiO₂, MgTiO₂, MgTiO₃, SrMgTiO₂, Al₂O₃, and Ta₂O₅. The constant-capacitance element can be manufactured through the same method as the variable capacitance element of the first embodiment.

Further, capacitance C (F) of the electrostatic capacitance element suitable for the present disclosure also depends on a used frequency f (Hz). The present disclosure is suitable for the capacitance element having the capacitance C (F) in which impedance Z (ohms) (Z=½πfc) is 2 ohms or more, preferably, 15 ohms or more, and more preferably 100 ohms or more.

### 10. Tenth Embodiment

### Resonance Circuit

Next, a resonance circuit according to a tenth embodiment of the present invention will be described. The present embodiment is an example in which the capacitance element of the present invention is applied to a resonance circuit, and particularly, an example in which the variable capacitance element 1 of the first embodiment is applied. Further, in the present embodiment, the resonance circuit is used for a non-contact IC card.

FIG. 58 is a block configuration view illustrating a receiving system circuit unit of a non-contact IC card 530 using the resonance circuit of the present embodiment. In the present embodiment, for simple description, a signal transmitting system (modulating system) circuit unit is not illustrated. The transmitting system circuit unit has the same configuration as the non-contact IC card of the conventional art.

The non-contact IC card includes a receiving unit 531 (antenna), a rectifying unit 532, and a signal processing unit 533 as illustrated in FIG. 58.

The receiving unit 531 is configured with a resonance circuit including a resonance coil 534 and a resonance capacitor 535, and a signal transmitted from an R/W (not shown) of the non-contact IC card 530 is received by the resonance circuit. In FIG. 58, the resonance coil 534 is divided into an inductance component 534a (L) and a resistance component 534b (r: about several ohms).

The resonance capacitor 535 is configured such that a capacitor 535a of capacitance Co and the variable capacitance element 1 in which capacitance Cv varies according to a voltage value (a received voltage value) of a received signal are connected in parallel. In other words, in the present embodiment, the variable capacitance element 1 is connected to the antenna (the resonance circuit including the resonance coil 534 and the capacitor 535a) of the related art.

As the capacitor 535a, similarly to the antenna of the related art, a capacitor formed of a paraelectric material is used. The capacitor 535a formed of a paraelectric material is low in the relative dielectric constant, and has capacitance that hardly varies regardless of a type (AC or DC) of an input voltage and a voltage value thereof. Thus, the capacitor 535a has very stable characteristics on an input signal. In the antenna of the related art, in order to prevent a resonance frequency of the antenna from deviating, a capacitor formed of a paraelectric material having high stability on an input signal is used.

Further, in an actual circuit, there is a variation in the inductance component L of the resonance coil 534 or a capacitance variation (about several pF) of the receiving unit 531 caused by parasitic capacitance of an input terminal of an integrated circuit in the signal processing unit 533, and the variation amount differs according to each non-contact IC card 530. In this regard, in the present embodiment, in order to suppress (correct) such influence, the capacitance Co is appropriately adjusted by trimming an electrode pattern of the capacitor 535a.

The rectifying unit 532 is configured with a half-wave rectifying circuit including a rectifying diode 536 and a rectifying capacitor 537, rectifies an AC voltage received by the receiving unit 531 to a DC current, and outputs the DC voltage.

The signal processing unit 533 is mostly configured with an integrated circuit (large scale integration (LSI)) of a semiconductor device, and demodulates an AC signal received by the receiving unit 531. The LSI in the signal processing unit 533 is driven by a DC voltage supplied from the rectifying unit 532. Further, an LSI used in the non-contact IC card of the related art may be used as the LSI.

In the present embodiment, in the variable capacitance element 1 used in the receiving unit, the center (the center of gravity) of the stacked internal electrode is arranged on a straight line in the stacked direction, and thus large residual stress is obtained. Thus, electrical characteristics are improved, and a large variable width is obtained at a low voltage. Further, since a change load on a resonance capacitor is reduced as a variable width increases, when a dielectric layer of a resonance capacitor is increased in thickness, a withstand voltage is improved, and thus it is possible to deal with a large AC voltage.

In the present embodiment, as the variable capacitance element of the resonance circuit, the variable capacitance element 1 of the first embodiment is used, but the variable capacitance element of the second embodiment may be used.

Additionally, the present technology may also be configured as below.

(1)

An electrostatic capacitance element, including:

a dielectric layer;

a capacitance element body configured to include at least a pair of internal electrodes formed with the dielectric layer interposed therebetween; and

an external terminal configured to be formed on a side surface of the capacitance element body and electrically connected to the internal electrode,

wherein stress occurring due to a difference in a linear expansion coefficient between the dielectric layer and the internal electrode is concentrated on a center of a capacitor configured with the dielectric layer and the pair of internal electrodes between which the dielectric layer is interposed.

(2)

The electrostatic capacitance element according to (1),

wherein the internal electrode includes an electrode body configuring a capacitor and a connection electrode that is connected to the electrode body and connected to the external terminal, and

wherein a plane shape of an electrode body of at least one internal electrode configuring the capacitor is a circular shape.

(3)

The electrostatic capacitance element according to (1) or (2),

wherein a width of an end portion of the connection electrode connected to the external terminal is a fourth (¼) or less of a diameter of the electrode body.

(4)

The electrostatic capacitance element according to any one of (1) to (3),

wherein a shape of a plane parallel to a plane of the capacitance element body on which the internal electrode is formed is a circular shape.

(5)

The electrostatic capacitance element according to any one of (1) to (4),

wherein a shape of the capacitance element body is a circular cylindrical shape.

(6)

The electrostatic capacitance element according to any one of (1) to (5),

wherein the internal electrode includes an electrode body configuring a capacitor and a connection electrode that is connected to the electrode body and connected to the external terminal, and

a plane shape of an electrode body of at least one internal electrode configuring the capacitor is an elliptical shape.

(7)

The electrostatic capacitance element according to any one of (1) to (5),

wherein the internal electrode includes an electrode body configuring a capacitor and a connection electrode that is connected to the electrode body and connected to the external terminal, and

wherein a plane shape of an electrode body of at least one internal electrode configuring the capacitor is a regular pentagonal or higher-order polygonal shape.

(8)

The electrostatic capacitance element according to any one of (1) to (7),

wherein the internal electrode includes an electrode body configuring a capacitor, a connection electrode that is connected to the electrode body and connected to the external terminal, and a floating electrode that is connected to neither the electrode body nor the external terminal.

(9)

The electrostatic capacitance element according to any one of (1) to (7),

wherein the internal electrode includes an electrode body configuring a capacitor and a plurality of connection electrodes that are connected to the electrode body and connected to the external terminal.

(10)

The electrostatic capacitance element according to (9),

wherein the electrode body is formed in a circular shape, and the plurality of connection electrodes are formed at equal intervals in a circumferential direction of the electrode body.

(11)

The electrostatic capacitance element according to any one of (1) to (3),

wherein a shape of the capacitance element body is a circular cylindrical shape.

(12)

The electrostatic capacitance element according to any one of (1) to (3),

wherein a shape of the capacitance element body is a columnar shape having a cross section of a square shape.

(13)

The electrostatic capacitance element according to any one of (1) to (3),

wherein a shape of the capacitance element body is a columnar shape having a cross section of an elliptical shape.

(14)

The electrostatic capacitance element according to any one of (1) to (3),

wherein a shape of the capacitance element body is a columnar shape having a cross section of a polygonal shape.

(15)

The electrostatic capacitance element according to any one of (1) to (3),

wherein a shape of the capacitance element body is a columnar shape having a cross section of a regular polygonal shape.

(16)

The electrostatic capacitance element according to any one of (1) to (15),

wherein a shape of a plane of the capacitance element body on which the internal electrode is formed is a same as a shape of an electrode body of the internal electrode.

(17)

The electrostatic capacitance element according to (1),

wherein a shape of a plane of the capacitance element body on which the internal electrode is formed and a shape of an electrode body of the internal electrode are a circular shape.

(18)

The electrostatic capacitance element according to any one of (1) to (17),

wherein the plurality of internal electrodes are stacked with a dielectric layer interposed therebetween, and a plurality of capacitors formed by the plurality of internal electrodes are connected in series in a stacked direction of the internal electrodes.

(19)

The electrostatic capacitance element according to (18),

wherein each of the stacked internal electrodes includes an electrode body configuring a capacitor and a plurality of connection electrodes that are connected to the electrode body and connected to the external terminal, and

the electrode bodies of the internal electrode have a same shape, and centers of gravity of the electrode bodies of the internal electrodes are arranged on a straight line in a stacked direction.

(20)

A resonance circuit, including:

a resonance capacitor configured to include an electrostatic capacitance element, the resonance capacitor including
a dielectric layer,
a capacitance element body configured to include at least a pair of internal electrodes formed with the dielectric layer interposed therebetween, and
an external terminal configured to be formed on a side surface of the capacitance element body and electrically connected to the internal electrode; and

a resonance coil configured to be connected to the resonance capacitor

wherein stress occurring due to a difference in a linear expansion coefficient between the dielectric layer and the internal electrode is concentrated on a center of a capacitor configured with the dielectric layer and the pair of internal electrodes between which the dielectric layer is interposed.

1. An electrostatic capacitance element, comprising:
a dielectric layer;
a capacitance element body configured to include at least a pair of internal electrodes formed with the dielectric layer interposed therebetween; and
an external terminal configured to be formed on a side surface of the capacitance element body and electrically connected to the internal electrode,
wherein stress occurring due to a difference in a linear expansion coefficient between the dielectric layer and the internal electrode is concentrated on a center of a capacitor configured with the dielectric layer and the pair of internal electrodes between which the dielectric layer is interposed.

2. The electrostatic capacitance element according to claim 1,
wherein the internal electrode includes an electrode body configuring a capacitor and a connection electrode that is connected to the electrode body and connected to the external terminal, and
wherein a plane shape of an electrode body of at least one internal electrode configuring the capacitor is a circular shape.

3. The electrostatic capacitance element according to claim 2,
wherein a width of an end portion of the connection electrode connected to the external terminal is a fourth (¼) or less of a diameter of the electrode body.

4. The electrostatic capacitance element according to claim 3,
wherein a shape of a plane parallel to a plane of the capacitance element body on which the internal electrode is formed is a circular shape.

5. The electrostatic capacitance element according to claim 4,
wherein a shape of the capacitance element body is a circular cylindrical shape.

6. The electrostatic capacitance element according to claim 1,
wherein the internal electrode includes an electrode body configuring a capacitor and a connection electrode that is connected to the electrode body and connected to the external terminal, and
a plane shape of an electrode body of at least one internal electrode configuring the capacitor is an elliptical shape.

7. The electrostatic capacitance element according to claim 1,
wherein the internal electrode includes an electrode body configuring a capacitor and a connection electrode that is connected to the electrode body and connected to the external terminal, and
wherein a plane shape of an electrode body of at least one internal electrode configuring the capacitor is a regular pentagonal or higher-order polygonal shape.

8. The electrostatic capacitance element according to claim 1,
wherein the internal electrode includes an electrode body configuring a capacitor, a connection electrode that is connected to the electrode body and connected to the external terminal, and a floating electrode that is connected to neither the electrode body nor the external terminal.

9. The electrostatic capacitance element according to claim 1,
wherein the internal electrode includes an electrode body configuring a capacitor and a plurality of connection electrodes that are connected to the electrode body and connected to the external terminal.

10. The electrostatic capacitance element according to claim 9,
wherein the electrode body is formed in a circular shape, and the plurality of connection electrodes are formed at equal intervals in a circumferential direction of the electrode body.

11. The electrostatic capacitance element according to claim 1,
wherein a shape of the capacitance element body is a circular cylindrical shape.

12. The electrostatic capacitance element according to claim 1,
wherein a shape of the capacitance element body is a columnar shape having a cross section of a square shape.

13. The electrostatic capacitance element according to claim 1,
wherein a shape of the capacitance element body is a columnar shape having a cross section of an elliptical shape.

14. The electrostatic capacitance element according to claim 1,
wherein a shape of the capacitance element body is a columnar shape having a cross section of a polygonal shape.

15. The electrostatic capacitance element according to claim 1,
wherein a shape of the capacitance element body is a columnar shape having a cross section of a regular polygonal shape.

16. The electrostatic capacitance element according to claim 1,
wherein a shape of a plane of the capacitance element body on which the internal electrode is formed is a same as a shape of an electrode body of the internal electrode.

17. The electrostatic capacitance element according to claim 1,
wherein a shape of a plane of the capacitance element body on which the internal electrode is formed and a shape of an electrode body of the internal electrode are a circular shape.

18. The electrostatic capacitance element according to claim 1,
wherein the plurality of internal electrodes are stacked with a dielectric layer interposed therebetween, and a plurality of capacitors formed by the plurality of internal electrodes are connected in series in a stacked direction of the internal electrodes.

19. The electrostatic capacitance element according to claim 18,
wherein each of the stacked internal electrodes includes an electrode body configuring a capacitor and a plurality of connection electrodes that are connected to the electrode body and connected to the external terminal, and
the electrode bodies of the internal electrode have a same shape, and centers of gravity of the electrode bodies of the internal electrodes are arranged on a straight line in a stacked direction.

20. A resonance circuit, comprising:
a resonance capacitor configured to include an electrostatic capacitance element, the resonance capacitor including
a dielectric layer,
a capacitance element body configured to include at least a pair of internal electrodes formed with the dielectric layer interposed therebetween, and
an external terminal configured to be formed on a side surface of the capacitance element body and electrically connected to the internal electrode; and
a resonance coil configured to be connected to the resonance capacitor
wherein stress occurring due to a difference in a linear expansion coefficient between the dielectric layer and the internal electrode is concentrated on a center of a capacitor configured with the dielectric layer and the pair of internal electrodes between which the dielectric layer is interposed.
